(19) United States
(12) Patent Application Publication
(10) Pub. No.: US 2025/0285275 A1
(43) Pub. Date: Sep. 11, 2025

(54) LESION IDENTIFICATION SYSTEMS AND METHODS

(71) Applicant: SHANGHAI UNITED IMAGING INTELLIGENCE CO., LTD., Shanghai (CN)

(72) Inventors: Yanbo CHEN, Shanghai (CN); Dongdong GU, Shanghai (CN); Yaozong GAO, Shanghai (CN); Yiqiang ZHAN, Shanghai (CN); Xiang Sean ZHOU, Shanghai (CN)

(73) Assignee: SHANGHAI UNITED IMAGING INTELLIGENCE CO., LTD., Shanghai (CN)

(21) Appl. No.: 19/218,572

(22) Filed: May 26, 2025

Related U.S. Application Data
(63) Continuation of application No. PCT/CN2023/138250, filed on Dec. 12, 2023.

(30) Foreign Application Priority Data
Dec. 12, 2022 (CN) 202211606244.5
May 23, 2023 (CN) 202310587014.7

(51) Int. Cl. G06T 7/00; G06T 7/11

(52) U.S. Cl. CPC G06T 7/0012; G06T 7/11; G06T 2207/10081; G06T 2207/20081; G06T 2207/30096; G06T 2207/30101

(57) ABSTRACT

A method and a system for lesion identification may be provided. A vascular image of a target subject may be obtained. A first segmentation result of blood vessels of the target subject may be generated based on the vascular image using a first segmentation model. A second segmentation result of one or more arteries and one or more lesion regions of the target subject may be generated based on the first segmentation result and the vascular image using a second segmentation model. A lesion identification result of the target subject may be generated based on the second segmentation result.

### CROSS-REFERENCE TO RELATED APPLICATIONS

This application is a continuation of International Patent Application PCT/CN2023/138250, filed on Dec. 12, 2023, which claims priority of Chinese Patent Application No. 202211606244.5 filed on Dec. 12, 2022, and Chinese Patent Application No. 202310587014.7 filed on May 23, 2023, the contents of each of which are incorporated herein by reference.

### TECHNICAL FIELD

The present disclosure relates to medical imaging technology, and in particular, to lesion identification systems and methods.

### BACKGROUND

Medical imaging technology has been widely used for generating a medical image of the interior of the body of a subject (e.g., a patient) for, e.g., clinical examinations, medical diagnosis, and/or treatment purposes. A lesion identification result of the subject obtained based on the medical image is vital for subsequent medical diagnosis and/or treatment. Thus, it may be desirable to develop lesion identification systems and methods with improved efficiency and accuracy.

### SUMMARY

According to an aspect of the present disclosure, a system for lesion identification may be provided. The system may include at least one storage device including a set of instructions and at least one processor. The at least one processor may be configured to communicate with the at least one storage device. When executing the set of instructions, the at least one processor may be configured to direct the system to perform one or more of the following operations. The system may obtain a vascular image of a target subject. The system may generate a first segmentation result of blood vessels of the target subject based on the vascular image using a first segmentation model. The system may also generate a second segmentation result of one or more arteries and one or more lesion regions of the target subject based on the first segmentation result and the vascular image using a second segmentation model. The system may further generate a lesion identification result of the target subject based on the second segmentation result.

In some embodiments, the first segmentation result may include a first segmentation image relating to the one or more arteries and one or more veins of the target subject.

In some embodiments, regions corresponding to the one or more arteries and the one or more veins may be expended in the first segmentation image.

In some embodiments, to generate a second segmentation result of one or more arteries and one or more lesion regions of the target subject based on the first segmentation result and the vascular image using a second segmentation model, the system may generate a centerline image relating to centerlines of the one or more arteries based on the first segmentation result. Further, the system may generate the second segmentation result using the second segmentation model based on the first segmentation result, the vascular image, and the centerline image.

In some embodiments, the first segmentation model may be generated by a training process including the following operations. The system may obtain a plurality of first training samples. Each of the plurality of first training samples may include a sample vascular image of a sample subject and a ground truth segmentation result relating to one or more arteries and one or more veins of the sample subject. Further, the system may generate the first segmentation model by training a first preliminary model based on the plurality of first training samples.

In some embodiments, the second segmentation model may be generated by a training process including the following operations. The system may obtain a plurality of second training samples. Each of the plurality of second training samples may include a sample vascular image of a sample subject, a sample first segmentation result, and a ground truth segmentation result of one or more arteries and one or more lesion regions of the sample subject, wherein the sample first segmentation result is obtained by inputting the sample vascular image into the first segmentation model. Further, the system may generate the second segmentation model by training a second preliminary model based on the plurality of second training samples.

In some embodiments, to generate a lesion identification result of the target subject based on the second segmentation result, the system may perform the following operations. For each of the one or more lesion regions, the system may determine a lesion connected component corresponding to the lesion region based on the second segmentation result from the vascular image. Further, the system may determine whether the lesion region is a false positive lesion region based on the lesion connected component using a lesion classification model. In response to determine that the lesion region is a false positive lesion region, the system may remove the lesion region from the one or more lesion regions to update the second segmentation result. Then, the system may generate the lesion identification result of the target subject based on the updated second segmentation result obtained by removing one or more false positive lesion regions.

In some embodiments, the lesion classification model may be generated by a training process including the following operations. The system may obtain a plurality of third training samples. Each of the plurality of third training samples may include a connected component corresponding to a sample lesion region in a sample image of a sample subject and a ground truth type of the sample lesion region. The system may generate the lesion classification model by training a third preliminary model based on the plurality of third training samples. The ground truth type of the sample lesion region may be determined by performing the following operations. The system may determine connected components corresponding to positive lesion regions of the sample subject in the sample image of the sample subject. Further, the system may determine the ground truth type of the sample lesion region based on the connected components corresponding to the positive lesion regions and the connected component corresponding to the sample lesion region.

In some embodiments, to generate a lesion identification result of the target subject based on the second segmentation result, the system may determine information related to the one or more lesion regions based on the second segmentation result. The system may also divide the one or more arteries into a plurality of levels of blood vessels based on the vascular image. The system may further determine the lesion identification result of the target subject based on the information related to the one or more lesion regions and the plurality of levels of blood vessels.

In some embodiments, the one or more arteries of the target subject may include a pulmonary artery, the one or more lesion regions include one or more embolisms, and the lesion identification result may include a pulmonary artery obstruction index (PAOI) of the target subject.

In some embodiments, the information related to the one or more lesion regions may include obstruction degree information of each of the one or more embolisms, and to determine information related to the one or more embolisms based on the second segmentation result, the system may perform the following operations. For each of the one or more embolisms, the system may determine a first connected component corresponding to the embolism and a second connected component corresponding to one or more branch vessels of the pulmonary artery including the embolism based on the second segmentation result. Further, the system may determine the obstruction degree information of the embolism using an embolism classification model based on the first connected component and the second connected component.

In some embodiments, to determine the obstruction degree information of the embolism using an embolism classification mode based on the first connected component and the second connected component, the system may determine resampling ratios based on a smallest bounding box of the first connected component. The system may resample the first connected component and the second connected component based on the resampling ratios to obtain a resampled first connected component and a resampled second connected component. Further, the system may determine the obstruction degree information of the embolism using the embolism classification mode based on the resampled first connected component and the resampled second connected component.

In some embodiments, the obstruction degree information of each of the one or more embolisms may indicate whether the embolism is a non-completely occluded embolism or a completely occluded embolism, the system may further perform the following operations. In response to determine that the one or more embolisms include one or more completely occluded embolisms, for each of the one or more completely occluded embolisms, the system may determine a non-completely occluded portion and a completely occluded portion of the completely occluded embolism using an embolism segmentation model based on the first connected component corresponding to the completely occluded embolism and the second connected component corresponding to one or more branch vessels of the pulmonary artery including the completely occluded embolism.

In some embodiments, the pulmonary artery may be divided into the plurality of levels of blood vessels by performing the following operations. The system may obtain a segmentation image of the pulmonary artery based on the vascular image. The system may determine a plurality of segmentation image blocks from the segmentation image of the pulmonary artery. For each of the plurality of segmentation image blocks, the system may determine a location feature of the segmentation image block and an original image block corresponding to the segmentation image block in the vascular image. Further, the system may determine a level corresponding to the segmentation image block using a level division model based on the segmentation image block, the location feature of the segmentation image block, and the original image block. Then, the system may divide the pulmonary artery into the plurality of levels of blood vessels based on the levels corresponding to the plurality of segmentation image blocks.

In some embodiments, the PAOI of the target subject may be determined by performing the following operations. For each of the one or more embolisms, the system may determine a second connected component corresponding to one or more branch vessels of the pulmonary artery including the embolism based on the information related to the embolism. The system may divide the one or more second connected components of the one or more embolisms into a plurality of regions. For each of the plurality of regions, the system may determine an embolism burden score of the region based on the information related to one or more embolisms located in the region and the level of blood vessels included in the region. Further, the system may determine the PAOI of the target subject based on the embolism burden scores of the plurality of regions.

According to another aspect of the present disclosure, a method for lesion identification may be provided. The method may be implemented on a computing device having at least one storage device and at least one processor. The method may include obtaining a vascular image of a target subject. The method may also include generating a first segmentation result of blood vessels of the target subject based on the vascular image using a first segmentation model. The method may also include generating a second segmentation result of one or more arteries and one or more lesion regions of the target subject based on the first segmentation result and the vascular image using a second segmentation model. The method may further include generating a lesion identification result of the target subject based on the second segmentation result.

According to yet another aspect of the present disclosure, a system for lesion identification may be provided. The system may include an obtaining module, a first generation module, a second generation module, and a third generation module. The obtaining module may be configured to obtain a vascular image of a target subject. The first generation module may be configured to generate a first segmentation result of blood vessels of the target subject based on the vascular image using a first segmentation model. The second generation module may be configured to generate a second segmentation result of one or more arteries and one or more lesion regions of the target subject based on the first segmentation result and the vascular image using a second segmentation model. The third generation module may be configured to generate a lesion identification result of the target subject based on the second segmentation result.

According to yet another aspect of the present disclosure, a non-transitory computer readable medium may be provided. The non-transitory computer readable medium may comprise at least one set of instructions for lesion identification. When executed by one or more processors of a computing device, the at least one set of instructions may cause the computing device to perform a method. The method may include obtaining a vascular image of a target subject. The method may also include generating a first segmentation result of blood vessels of the target subject based on the vascular image using a first segmentation model. The method may also include generating a second segmentation result of one or more arteries and one or more lesion regions of the target subject based on the first segmentation result and the vascular image using a second segmentation model. The method may further include generating a lesion identification result of the target subject based on the second segmentation result.

According to yet another aspect of the present disclosure, a device for lesion identification may be provided. The device may include at least one processor and at least one storage device for storing a set of instructions. When the set of instructions may be executed by the at least one processor, the device performs the methods for lesion identification.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary medical system according to some embodiments of the present disclosure;

FIG. 2 is a schematic diagram illustrating exemplary hardware and/or software components of an exemplary computing device according to some embodiments of the present disclosure;

FIG. 3 is a block diagram illustrating an exemplary processing device according to some embodiments of the present disclosure;

FIG. 4 is a flowchart illustrating an exemplary process for lesion identification according to some embodiments of the present disclosure;

FIG. 5 is a schematic diagram illustrating an exemplary lesion identification process according to some embodiments of the present disclosure;

FIG. 6 is a flowchart illustrating an exemplary process for determining a pulmonary artery obstruction index (PAOI) of a target subject according to some embodiments of the present disclosure;

FIG. 7 is a schematic diagram illustrating exemplary embolisms according to some embodiments of the present disclosure;

FIG. 8 is a flowchart illustrating an exemplary process for determining obstruction degree information according to some embodiments of the present disclosure;

FIG. 9 is a flowchart illustrating an exemplary process for pulmonary artery division according to some embodiments of the present disclosure;

FIG. 10 is a schematic diagram illustrating an exemplary process for determining features of fused image blocks according to some embodiments of the present disclosure;

FIG. 11 is a schematic diagram illustrating an exemplary process for determining a PAOI of a target subject according to some embodiments of the present disclosure; and

FIG. 12 is a schematic diagram illustrating an exemplary process for determining obstruction degree information of one or more embolisms according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, sections or assembly of different levels in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module, or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items. The term “pixel” and “voxel” in the present disclosure are used interchangeably to refer to an element of an image. An anatomical structure shown in an image of a subject (e.g., a patient) may correspond to an actual anatomical structure existing in or on the subject's body. For example, a body part shown in an image may correspond to an actual body part existing in or on the subject's body, and a feature point in an image may correspond to an actual feature point existing in or on the subject's body. For the convenience of descriptions, an anatomical structure shown in an image and its corresponding actual anatomical structure are used interchangeably. For example, the chest of the subject refers to the actual chest of the subject or a region representing the chest in an image of the subject.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

In the present disclosure, a representation of a subject (e.g., an object, a patient, or a portion thereof) in an image may be referred to as “subject” for brevity. For instance, a representation of an organ, tissue (e.g., a heart, a liver, a lung), or an ROI in an image may be referred to as the organ, tissue, or ROI, for brevity. Further, an image including a representation of a subject, or a portion thereof, may be referred to as an image of the subject, or a portion thereof, or an image including the subject, or a portion thereof, for brevity. Still further, an operation performed on a representation of a subject, or a portion thereof, in an image may be referred to as an operation performed on the subject, or a portion thereof, for brevity. For instance, a segmentation of a portion of an image including a representation of an ROI from the image may be referred to as a segmentation of the ROI for brevity.

Conventional lesion identification approaches obtain a lesion identification result of blood vessels by segmenting blood vessels and one or more lesion regions of a subject using an image segmentation algorithm. Exemplary conventional image segmentation algorithms may include a thresholding segmentation algorithm, a compression-based algorithm, an edge detection algorithm, a machine learning-based segmentation algorithm, or the like, or any combination thereof. However, the segmentation result of blood vessels and one or more lesion regions using conventional image segmentation algorithms has a low accuracy for some reasons. For example, regions corresponding to thin blood vessels or small lesions in a segmentation image are prone to have breakage. As another example, the one or more arteries and the one or more veins are often segmented wrongly, specifically at a position where one or more arteries and one or more veins intersect with each other. As still another example, due to different sizes and positions of lesions, the lesion segmentation result has a high false positive rate. Therefore, the lesion identification result obtained using the conventional lesion identification approaches has a low accuracy.

An aspect of the present disclosure relates to systems and methods for lesion identification. The systems may obtain a vascular image of a target subject. The systems may generate a first segmentation result of blood vessels of the target subject based on the vascular image using a first segmentation model. In some embodiments, the first segmentation result may include a first segmentation image relating to the one or more arteries and one or more veins of the target subject. The systems may also generate a second segmentation result of the one or more arteries and one or more lesion regions of the target subject based on the first segmentation result and the vascular image using a second segmentation model. Further, the systems may generate a lesion identification result of the target subject based on the second segmentation result.

Compared with the conventional lesion identification approaches, the systems and methods of the present disclosure may perform two stages of image segmentations using the first segmentation model and the second segmentation model in sequence, which may generate the second segmentation result with the improved accuracy based on the vascular image and the first segmentation result, thereby improving the accuracy of the lesion identification result generated based on the second segmentation result.

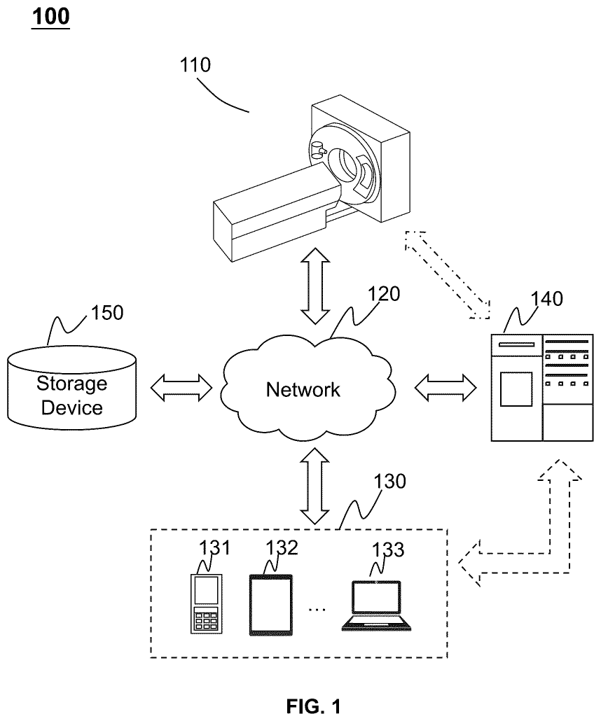

FIG. 1 is a schematic diagram illustrating an exemplary medical system 100 according to some embodiments of the present disclosure. As shown in FIG. 1, the medical system 100 may include an imaging device 110, a network 120, one or more terminals 130, a processing device 140, and a storage device 150. In some embodiments, the imaging device 110, the terminal(s) 130, the processing device 140, and/or the storage device 150 may be connected to and/or communicate with each other via a wireless connection (e.g., the network 120), a wired connection, or a combination thereof. The connection between the components of the medical system 100 may be variable.

The imaging device 110 may be configured to scan a subject (or a part of the subject) to acquire medical image data associated with the subject. The subject may include a biological subject and/or a non-biological subject. For example, the subject may be a human being, an animal, or a portion thereof. As another example, the subject may be a phantom. In some embodiments, the subject may be a patient (or a portion thereof). The medial image data relating to the subject may be used for generating an anatomical image (e.g., a CT image, an MRI image, etc.) of the subject. The anatomical image may illustrate an internal structure of the subject.

In some embodiments, the imaging device 110 may include a single-modality scanner and/or multi-modality scanner. The single modality scanner may include, for example, a magnetic resonance angiography (MRA) scanner, a computed tomography angiography (CTA) scanner, an X-ray scanner, a CT scanner, a magnetic resonance imaging (MRI) scanner, an ultrasonography scanner, a positron emission tomography (PET) scanner, a Digital Radiography (DR) scanner, or the like, or any combination thereof. The multi-modality scanner may include, for example, an X-ray imaging-magnetic resonance imaging (X-ray-MRI) scanner, a positron emission tomography-X-ray imaging (PET-X-ray) scanner, a single-photon emission computed tomography-magnetic resonance imaging (SPECT-MRI) scanner, a positron emission tomography-computed tomography (PET-CT) scanner, etc. In some embodiments, the imaging device 110 may be a computed tomography angiography (CTA) scanner. It should be noted that the imaging device 110 described below is merely provided for illustration purposes, and is not intended to limit the scope of the present disclosure.

The network 120 may include any suitable network that can facilitate the exchange of information and/or data for the medical system 100. In some embodiments, one or more components of the medical system 100 (e.g., the imaging device 110, the processing device 140, the storage device 150, the terminal(s) 130) may communicate information and/or data with one or more other components of the medical system 100 via the network 120. For example, the processing device 140 may obtain image data (a vascular image) from the imaging device 110 via the network 120.

The terminal(s) 130 may be connected to and/or communicate with the imaging device 110, the processing device 140, and/or the storage device 150. For example, the terminal(s) 130 may display a vascular image, a segmentation image, a lesion identification result of a subject, etc. In some embodiments, the terminal(s) 130 may include a mobile device 131, a tablet computer 132, a laptop computer 133, or the like, or any combination thereof. In some embodiments, the terminal(s) 130 may be part of the processing device 140.

The processing device 140 may process data and/or information obtained from the imaging device 110, the storage device 150, the terminal(s) 130, or other components of the medical system 100. For example, the processing device 140 may generate a lesion identification result of a target subject by processing a vascular image of the target subject. As another example, the processing device 140 may generate one or more machine learning models used for image processing and/or lesion identification.

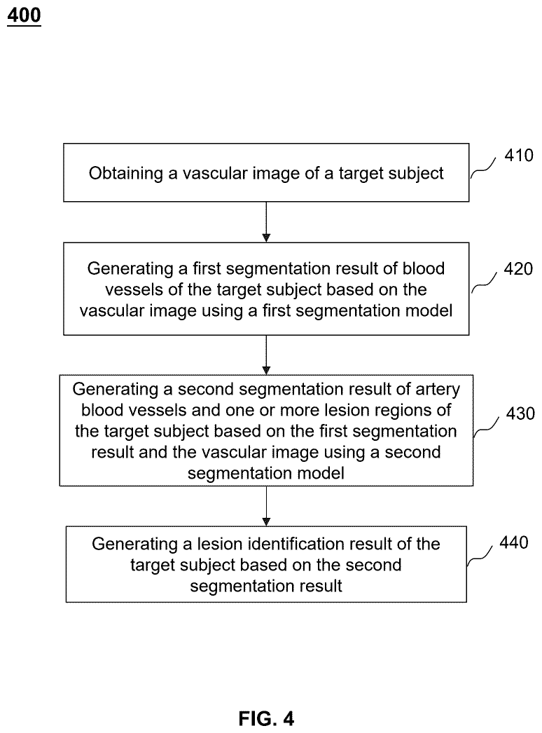

In some embodiments, the processing device 140 (e.g., one or more modules illustrated in FIG. 4) may execute instructions and may accordingly be directed to perform one or more processes (e.g., processes 400, 600, 800, and 900) described in the present disclosure. For example, each of the one or more processes may be stored in a storage device (e.g., the storage device 150) as a form of instructions, and invoked and/or executed by the processing device 140.

In some embodiments, the processing device 140 may be a single server or a server group. In some embodiments, the processing device 140 may be local to or remote from the medical system 100. Merely for illustration, only one processing device 140 is described in the medical system 100. However, it should be noted that the medical system 100 in the present disclosure may also include multiple processing devices. Thus operations and/or method steps that are performed by one processing device 140 as described in the present disclosure may also be jointly or separately performed by the multiple processing devices. For example, if in the present disclosure the processing device 140 of the medical system 100 executes both process A and process B, it should be understood that the process A and the process B may also be performed by two or more different processing devices jointly or separately in the medical system 100 (e.g., a first processing device executes process A and a second processing device executes process B, or the first and second processing devices jointly execute processes A and B).

The storage device 150 may store data, instructions, and/or any other information. In some embodiments, the storage device 150 may store data obtained from the processing device 140, the terminal(s) 130, and/or the imaging device 110. For example, the storage device 150 may store image data (e.g., a vascular image of a target subject) collected by the imaging device 110. As another example, the storage device 150 may store a lesion identification result of the target subject. In some embodiments, the storage device 150 may store data and/or instructions that the processing device 140 may execute or use to perform exemplary methods described in the present disclosure.

It should be noted that the above description of the medical system 100 is intended to be illustrative, and not to limit the scope of the present disclosure. Many alternatives, modifications, and variations will be apparent to those skilled in the art. The features, structures, methods, and other characteristics of the exemplary embodiments described herein may be combined in various ways to obtain additional and/or alternative exemplary embodiments. For example, the medical system 100 may include one or more additional components. Additionally or alternatively, one or more components of the medical system 100 described above may be omitted. As another example, two or more components of the medical system 100 may be integrated into a single component.

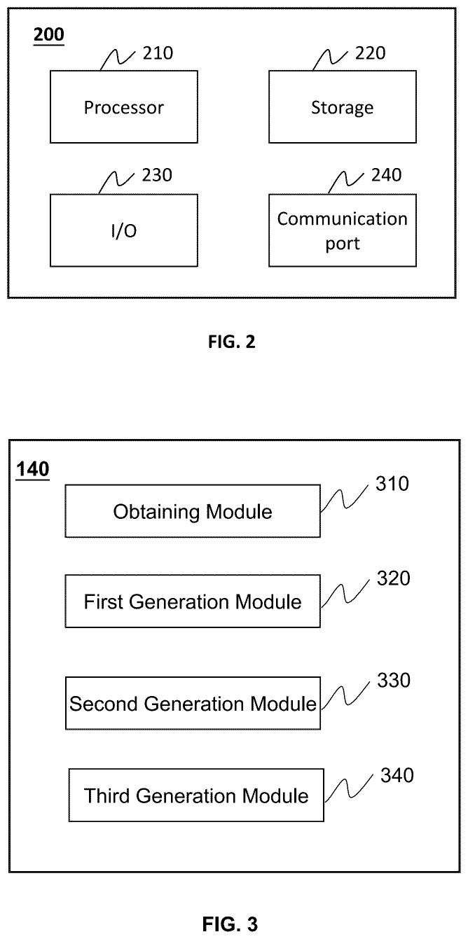

FIG. 2 is a schematic diagram illustrating exemplary hardware and/or software components of an exemplary computing device according to some embodiments of the present disclosure. In some embodiments, the processing device 140 may be implemented on the computing device 200. As illustrated in FIG. 2, the computing device 200 may include a processor 210, a storage 220, an input/output (I/O) 230, and a communication port 240.

The processor 210 may execute computer instructions (program code) and perform functions of the processing device 140 in accordance with techniques described herein. The computer instructions may include routines, programs, objects, components, signals, data structures, procedures, modules, and functions, which perform particular functions described herein. Merely for illustration purposes, only one processor is described in the computing device 200. However, it should be noted that the computing device 200 in the present disclosure may also include multiple processors, and thus operations of a method that are performed by one processor as described in the present disclosure may also be jointly or separately performed by the multiple processors.

The storage 220 may store data/information obtained from the imaging device 110, the terminal(s) 130, the storage device 150, or any other component of the medical system 100. In some embodiments, the storage 220 may include a mass storage device, a removable storage device, a volatile read-and-write memory, a read-only memory (ROM), or the like, or any combination thereof. In some embodiments, the storage 220 may store one or more programs and/or instructions to perform exemplary methods described in the present disclosure.

The I/O 230 may input or output signals, data, or information. In some embodiments, the I/O 230 may enable user interaction with the processing device 140. In some embodiments, the I/O 230 may include an input device and an output device.

The communication port 240 may be connected to a network (e.g., the network 120) to facilitate data communications. The communication port 240 may establish connections between the processing device 140 and the imaging device 110, the terminal(s) 130, or the storage device 150. The connection may be a wired connection, a wireless connection, or combination of both that enables data transmission and reception.

It should be noted that the above description of the computing device 200 is merely provided for the purposes of illustration, and not intended to limit the scope of the present disclosure. For persons having ordinary skills in the art, multiple variations and modifications may be made under the teachings of the present disclosure.

FIG. 3 is a block diagram illustrating exemplary processing device 140 according to some embodiments of the present disclosure.

As shown in FIG. 3, the processing device 140 may include an obtaining module 310, a first generation module 320, a second generation module 330, and a third generation module 340. As described in FIG. 1, the medical system 100 in the present disclosure may also include multiple processing devices, and the obtaining module 310, the first generation module 320, the second generation module 330, and the third generation module 340 may be components of different processing devices.

The obtaining module 310 may be configured to obtain information relating to the medical system 100. For example, the obtaining module 310 may obtain a vascular image of a target subject. More descriptions regarding the obtaining of the vascular image of the target subject may be found elsewhere in the present disclosure. See, e.g., operation 410 in FIG. 4, and relevant descriptions thereof.

The first generation module 320 may be configured to generate a first segmentation result of blood vessels of the target subject based on the vascular image using a first segmentation model. More descriptions regarding the generation of the first segmentation result of blood vessels of the target subject may be found elsewhere in the present disclosure. See, e.g., operation 420 in FIG. 4, and relevant descriptions thereof.

The second generation module 330 may be configured to generate a second segmentation result of one or more arteries and one or more lesion regions of the target subject based on the first segmentation result and the vascular image using a second segmentation model. More descriptions regarding the generation of the second segmentation result of one or more arteries and one or more lesion regions of the target subject may be found elsewhere in the present disclosure. See, e.g., operation 430 in FIG. 4, and relevant descriptions thereof.

The third generation module 340 may be configured to generate a lesion identification result of the target subject based on the second segmentation result. More descriptions regarding the generation of the lesion identification result of the target subject may be found elsewhere in the present disclosure. See, e.g., operation 410 in FIG. 4, and relevant descriptions thereof.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, any one of the modules may be divided into two or more units. For instance, the obtaining module 310 may be divided into two units configured to acquire different data. In some embodiments, the processing device 140 may include one or more additional modules, such as a storage module (not shown) for storing data.

FIG. 4 is a flowchart illustrating an exemplary process 400 for lesion identification according to some embodiments of the present disclosure.

In 410, the processing device 140 (e.g., the obtaining module 310) may obtain a vascular image of a target subject.

The target subject may include a biological subject and/or a non-biological subject that includes a blood vessel region. For example, the target subject may be a human being, an animal, or a portion thereof (e.g., the lungs of a patient). As another example, the target subject may be a phantom that simulates a blood vessel region. In some embodiments, the target subject may be a patient (or a portion thereof), and the target image may include at least the blood vessel region of the patient. The blood vessels may include one or more arteries (e.g., a pulmonary artery, a coronary artery, etc.). In some embodiments, the blood vessels may further include one or more veins.

In some embodiments, the vascular image may include a 2D image (e.g., a slice image), a 3D image, a 4D image (e.g., a series of 3D images over time), and/or any related image data (e.g., scan data, projection data), or the like. In some embodiments, the vascular image may include a medical image (e.g., in the form of a digital imaging communication in medicine (DICOM) image file) generated by a biomedical imaging technique as described elsewhere in this disclosure. For example, the vascular image may be a medical image obtained using a computed tomography angiography (CTA) technique. As another example, the vascular image may include a DR image, an MR image, a PET image, a CT image, a PET-CT image, a PET-MR image, an ultrasound image, etc. In some embodiments, the vascular image may include a 3D enhanced CT image.

In some embodiments, the vascular image may be generated based on image data acquired using the imaging device 110 of the medical system 100 or an external imaging device. In some embodiments, the vascular image may be previously generated and stored in a storage device (e.g., the storage device 150, the storage 220, or an external source). The processing device 140 may retrieve the vascular image from the storage device.

In some embodiments, the processing device 140 may perform one or more preprocesses (e.g., a noise reduction, a gray value normalization, etc.) on the vascular image, and further perform the following operations 420-440 based on the preprocessed vascular image.

In 420, the processing device 140 (e.g., the first generation module 320) may generate a first segmentation result of blood vessels of the target subject based on the vascular image using a first segmentation model.

The first segmentation result may indicate the blood vessels of the target subject segmented from the vascular image. For example, the first segmentation result may indicate the one or more arteries (e.g., a pulmonary artery, a coronary artery, etc.) of the target subject. As another example, the first segmentation result may indicate the one or more arteries and the one or more veins of the target subject.

In some embodiments, the first segmentation result may be represented as a first segmentation image of the blood vessels generated based on the vascular image.

As used herein, in a segmentation image, different regions (e.g., a region of interest (ROI), a background region) may be displayed in different colors or with different labels. Merely by way of example, the segmentation image may be represented as a matrix in which elements having a label of “1” represent physical points of an ROI (e.g., the blood vessels) and elements having a label of “0” represent physical points of the background region. If there are multiple ROIs, the different ROIs may be represented with different colors or different labels in the segmentation image.

In some embodiments, the first segmentation image may relate to the one or more arteries and one or more veins of the target subject. That is, the first segmentation image may include both the segmentation results of the one or more arteries and the one or more veins. For example, in the first segmentation image, pixels (or voxels) corresponding to the one or more arteries, the one or more veins, and the background region of the target subject may be marked with different labels.

In some embodiments, regions corresponding to the one or more arteries and the one or more veins may be expended in the first segmentation image. For example, the regions corresponding to the one or more arteries and the one or more veins may be expanded outward to a certain size, so that the expanded regions include the one or more arteries and the one or more veins.

In some embodiments, the first segmentation model may be a trained model (e.g., a machine learning model) used for blood vessel segmentation. Merely by way of example, the vascular image may be inputted into the first segmentation model, and the first segmentation model may output the first segmentation result and/or information (e.g., position information and/or contour information) relating to the blood vessels. In some embodiments, the first segmentation model may include a deep learning model, such as a deep neural network (DNN) model, a convolutional Neural Network (CNN) model (e.g., a V-Net model, a U-Net model, a Link-Net model, etc.), a recurrent neural network (RNN) model, a feature pyramid network (FPN) model, a generative adversarial network (GAN) model, a fully convolutional network (FCN) model, a residual network (ResNet) model, a dense convolutional network (DsenseNet) model, or the like, or any combination thereof.

In some embodiments, the processing device 140 may obtain the first segmentation model from one or more components of the medical system 100 (e.g., the storage device 150, the terminals(s) 130) or an external source via a network (e.g., the network 120). For example, the first segmentation model may be previously trained by a computing device (e.g., the processing device 140 or a computing device of a vendor of the first segmentation model), and stored in a storage device (e.g., the storage device 150, the storage 220) of the medical system 100. The processing device 140 may access the storage device and retrieve the first segmentation model. In some embodiments, the first segmentation model may be generated according to a machine learning algorithm.

Merely by way of example, the first segmentation model may be trained according to a supervised learning algorithm by the processing device 140 or another computing device (e.g., a computing device of a vendor of the first segmentation model). The processing device 140 may obtain a plurality of first training samples and generate the first segmentation model by training a first preliminary model based on the plurality of first training samples. Each first training sample may include a sample vascular image of a sample subject and a ground truth segmentation result one or more arteries, wherein the ground truth segmentation result can be used as a ground truth (also referred to as a label) for model training. In some embodiments, the ground truth segmentation result may be similar to the first segmentation result. For example, the ground truth segmentation result may be represented as a ground truth segmentation image including the one or more arteries of the sample subject. In some embodiments, the ground truth segmentation result may be defined by a user or may be automatically determined by a training device.

In some embodiments, the ground truth segmentation result may relate to the one or more arteries and the one or more veins of the sample subject. For example, the ground truth segmentation result may be represented as a ground truth segmentation image including the one or more arteries and the one or more veins of the sample subject. In this way, during the training, the first preliminary model may learn the characteristics of blood vessels more accurately and effectively by combining information of both the one or more arteries and the one or more veins, which may improve the performance of the first segmentation model, in turn thereby improving the accuracy of the first segmentation result generated by the first segmentation model.

Image segmentation models usually generate segmentation result by classifying voxels in an image. Deep learning segmentation networks are usually constructed based on image classification networks (e.g., a visual geometry group (VGG), an AlexNet, a ResNet, etc.). The segmentation networks usually map an input image to a feature space for voxel classification through convolution and downsampling operations. Its advantages include that the segmentation networks can extract a large amount of contextual image information during the downsampling and convolution. This global information combined with local image features can better assist the segmentation networks in decision-making. However, the downsampling operation may lead to the loss of image spatial scale information, resulting in the inability to predict structures of regions of interest (ROIs) with a relatively small size (e.g., thin blood vessel segments) in the large-scale feature space, resulting in the existence of breakage in the thin blood vessels in the segmentation result. In addition, incorrect segmentation of arterial blood vessels and one or more veins may occur where one or more arteries and one or more veins intersect with each other.

In order to solve the above problem, in some embodiments, regions corresponding to the one or more arteries and the one or more veins are expended in the ground truth segmentation result. In this case, the ground truth segmentation result may be represented as a ground truth segmentation image including the expended one or more arteries and the expended one or more veins of a sample subject. Since the expended blood vessels are relatively thick, their morphological topology can still be maintained even after the downsampling operation is performed on the expended blood vessels. In this way, the performance of the first segmentation model may be improved, thereby improving the accuracy of the first segmentation result generated by the first segmentation model.

In some embodiments, resolutions of the sample vascular images of the first training samples may be reduced to improve the efficiency of the training of the first preliminary model.

The first preliminary model to be trained may include one or more model parameters, such as the number (or count) of layers, the number (or count) of nodes, a first loss function, or the like, or any combination thereof. Before training, the first preliminary model may have one or more initial parameter values of the model parameter(s).

The training of the first preliminary model may include one or more iterations to iteratively update the model parameters of the first preliminary model based on the first training sample(s) until a termination condition is satisfied in a certain iteration. Exemplary termination conditions may be that the value of a loss function obtained in the certain iteration is less than a threshold value, that a certain count of iterations has been performed, that the loss function converges such that the difference of the values of the loss function obtained in a previous iteration and the current iteration is within a threshold value, etc. The loss function may be used to measure a discrepancy between a segmentation result predicted by the first preliminary model in an iteration and the ground truth segmentation result. For example, the first sample image of each first training sample may be inputted into the first preliminary model, and the first preliminary model may output a predicted segmentation result of the training sample. The loss function may be used to measure a difference between the predicted segmentation result and the ground truth segmentation result of each first training sample. Exemplary loss functions may include a focal loss function, a log loss function, a cross-entropy loss function, a Dice ratio loss function, a Hinge loss function, a quadratic loss function, or the like. If the termination condition is not satisfied in the current iteration, the processing device 140 may further update the first preliminary model to be used in a next iteration according to, for example, a backpropagation algorithm. If the termination condition is satisfied in the current iteration, the processing device 140 may designate the first preliminary model in the current iteration as the first segmentation model.

In some embodiments, the blood vessels (e.g., the one or more arteries and the one or more veins) may be segmented from the vascular image via other manners. For example, the blood vessels may be segmented from the vascular image manually by a user (e.g., a doctor, an imaging specialist, a technician) by, for example, drawing bounding boxes on the vascular image displayed on a user interface. Alternatively, the vascular image may be segmented by the processing device 140 automatically according to an image analysis algorithm (e.g., an image segmentation algorithm). For example, the processing device 140 may perform image segmentation on the vascular image using an image segmentation algorithm. Exemplary image segmentation algorithm may include a thresholding segmentation algorithm, a compression-based algorithm, an edge detection algorithm, a machine learning-based segmentation algorithm, a level set algorithm, a region growing algorithm, a cluster segmentation algorithm, or the like, or any combination thereof.

In some embodiments, the processing device 140 may transmit the vascular image to another computing device (e.g., a computing device of a vendor of the first segmentation model). The computing device may segment the blood vessels from the vascular image and transmit the first segmentation result back to the processing device 140. In some embodiments, operation 420 may be omitted. The blood vessels may be previously segmented from the vascular image and stored in a storage device (e.g., the storage device 150, the storage 220, or an external source). The processing device 140 may retrieve the first segmentation result from the storage device.

In 430, the processing device 140 (e.g., the second generation module 330) may generate a second segmentation result of one or more arteries and one or more lesion regions of the target subject based on the first segmentation result and the vascular image using a second segmentation model.

The second segmentation result may indicate the one or more arteries and the one or more lesion regions of the target subject segmented from the vascular image. In some embodiments, the one or more lesion regions may be located in the one or more arteries. For example, the second segmentation result may indicate a pulmonary artery and one or more embolisms located in the pulmonary artery of the target subject.

In some embodiments, the second segmentation result may be represented as a second segmentation image of the one or more arteries and the one or more lesion regions generated based on the first segmentation result and the vascular image. For example, the second segmentation result may be represented as a second segmentation image of the one or more arteries and the one or more lesion regions.

In some embodiments, the second segmentation result may include an artery segmentation image and a lesion segmentation image. In some embodiments, the artery segmentation image may include an unobstructed artery segmentation image or a complete artery segmentation image. The unobstructed artery segmentation image may indicate a portion of the one or more arteries other than the one or more lesion regions (also referred to as an unobstructed portion of the one or more arteries) segmented from the vascular image. The complete artery segmentation image may indicate the complete one or more arteries segmented from the vascular image. The lesion segmentation image may indicate the one or more lesion regions of the target subject segmented from the vascular image. In some embodiments, the processing device 140 may combine the artery segmentation image and the lesion segmentation image into the second segmentation image. In some embodiments, the processing device 140 may divide the second segmentation image into the artery segmentation image and the lesion segmentation image.

In some embodiments, the processing device 140 may generate a centerline image relating to centerlines of the one or more arteries based on the first segmentation result, and generate the second segmentation result using the second segmentation model based on the first segmentation result, the vascular image, and the centerline image. The centerline image may be a segmentation image of the centerlines of the one or more arteries. In some embodiments, the processing device 140 may determine the centerlines of the one or more arteries based on the first segmentation result. For example, the processing device 140 may determine an artery region corresponding to the one or more arteries from the first segmentation image, and obtain the centerlines of the plurality of the one or more arteries by performing a skeletonization processing, a corrosion processing, etc., on the artery region. As another example, the processing device 140 may obtain the centerlines of the plurality of the one or more arteries by processing the first segmentation image using a centerline extraction algorithm.

In some embodiments, the second segmentation model may be a trained model (e.g., a machine learning model) used for segmenting both one or more arteries and lesion regions. Merely by way of example, the vascular image and at least one of the first segmentation result and the centerline image may be inputted into the second segmentation model, and the second segmentation model may output the second segmentation result and/or information (e.g., position information and/or contour information) relating to the one or more arteries and the one or more lesion regions. In some embodiments, the second segmentation model may include any model as described elsewhere in the present disclosure (e.g., operation 420).

In some embodiments, the obtaining of the second segmentation model may be performed in a similar manner as that of the first segmentation model described in connection with operation 420. In some embodiments, the second segmentation model may be generated according to a machine learning algorithm. Merely by way of example, the processing device 140 may obtain a plurality of second training samples, and generate the second segmentation model by training a second preliminary model based on the plurality of second training samples. In some embodiments, each second training sample may include a sample vascular image of a sample subject, a sample first segmentation result, and a ground truth segmentation result of one or more arteries and one or more lesion regions of the sample subject. The sample first segmentation result may be obtained by inputting the sample vascular image into the first segmentation model. Since the sample first segmentation result includes morphological features of one or more arteries of the sample subject, the sample first segmentation result is used as an input for training of the second preliminary model, which may enable the second preliminary model to capture more accurate artery characteristics (e.g., characteristics of relatively thin blood vessels or lesions) during the training process. Therefore, in this way, the performance of the second segmentation model may be further improved, thereby improving the accuracy of the second segmentation result generated by the second segmentation model. For example, one or more arteries (especially the relatively thin blood vessels) are more consecutive in the second segmentation result, and the lesion identification accuracy can be improved.

In some embodiments, each second training sample may further include a sample centerline image including centerlines of the one or more arteries of the sample subject. Since the sample centerline image includes morphological topology features of the one or more arteries, the sample centerline image is used as an input for training of the second preliminary model, which may accelerate the convergence of the second preliminary model and enable the second preliminary model to further capture more accurate blood vessel characteristics during the training process. Therefore, in this way, the performance of the second segmentation model may be further improved, thereby further improving the accuracy of the second segmentation result generated by the second segmentation model.

In some embodiments, the training of the second preliminary model based on the plurality of second training samples may be performed in a similar manner as that of the first preliminary model based on the plurality of first training samples as described in connection with operation 420, and the descriptions of which are not repeated here.

In some embodiments, resolutions of the sample vascular images of the second training samples may be increased to improve the accuracy of the training of the second preliminary model.

In some embodiments, the first segmentation model and the second segmentation model may be two individual segmentation models. Alternatively, the first segmentation model and the second segmentation model may be integrated into a single segmentation model. For example, the first segmentation model and the second segmentation model may be integrated into two cascaded portions of the single segmentation model using a cascading strategy.

In some embodiments, the first segmentation model and the second segmentation model may be synchronously trained. In some embodiments, during the synchronous training of the first segmentation model and the second segmentation model, model parameters of the first preliminary model and the second preliminary model may be iteratively updated based on the loss functions for training the first preliminary model and the second preliminary model. In some embodiments, the first segmentation model and the second segmentation model may be respectively trained. That is, after the training of the first segmentation model is completed, the second segmentation model may be trained based on the first segmentation model.

In some embodiments, the second segmentation result output by the segmentation model may be referred to as the initial second segmentation result. In some embodiments, the processing device 140 may directly designate the initial second segmentation result as the second segmentation result. In some embodiments, the processing device 140 may generate the second segmentation result by processing the initial second segmentation result.

For example, the initial second segmentation result may include an initial lesion segmentation image and an initial artery segmentation image, and the processing device 140 may generate the lesion segmentation image and the artery segmentation image by processing the initial lesion segmentation image and the initial artery segmentation image. Specifically, the processing device 140 may determine one or more connected components (also referred to as connected domains) corresponding to the one or more lesion regions (also referred to as lesion connected components) in the initial lesion segmentation image. The processing device 140 may determine whether there are one or more reference lesion connected components with sizes smaller than a size threshold among the one or more lesion connected components. In some embodiments, the size of a connected component may be represented via an amount of pixels (or voxels) included in the connected component. In response to determining that there are one or more reference lesion connected components, the processing device 140 may remove the reference lesion connected component(s) from the initial lesion segmentation image, that is, replace the reference lesion connected component(s) with the background region in the initial lesion segmentation image, to generate the lesion segmentation image. In some embodiments, the processing device 140 may generate the artery segmentation image based on the initial artery segmentation image in a similar manner as how the lesion segmentation image is generated based on the initial lesion segmentation image, and the descriptions of which are not repeated here. The size threshold used for processing the initial artery segmentation image may be the same as or different from the size threshold used for processing initial lesion segmentation image. As another example, the initial second segmentation result may be represented as an initial second segmentation image of the one or more arteries and the one or more lesion regions. In response to determining that there are one or more reference lesion connected components, for each reference lesion connected component, the processing device 140 may determine whether the reference lesion connected component and the one or more arteries partially overlap. In response to determining that the reference lesion connected component and the one or more arteries partially overlap, the processing device 140 may replace the color or the label corresponding to the reference lesion connected component with the color or the label corresponding to the one or more arteries in the initial second segmentation image. In response to determining that the reference lesion connected component and the one or more arteries do not overlap, the processing device 140 may replace the color or the label corresponding to the reference lesion connected component with the color or the label corresponding to the background region in the initial second segmentation image.

In some embodiments, the processing device 140 may generate the artery segmentation image by removing one or more discontinuous portions of the one or more arteries from the initial artery segmentation image. In some embodiments, the processing device 140 may combine the lesion segmentation image and the artery segmentation image into an initial second segmentation image. Further, the processing device 140 may generate the second segmentation image base on the initial second segmentation image in a similar manner as how the lesion segmentation image is generated based on the initial lesion segmentation image, and the descriptions of which are not repeated here. The size threshold used for processing the initial second segmentation image may be the same as or different from the size threshold used for processing initial lesion segmentation image. In this way, some discontinuous regions with relatively small sizes corresponding to the one or more arteries and the one or more lesion regions may be removed from the initial second segmentation result, which may improve the consecutiveness of the one or more arteries and the one or more lesion regions in the second segmentation result, thereby improving the accuracy of the second segmentation result.

In 440, the processing device 140 (e.g., the third generation module 340) may generate a lesion identification result of the target subject based on the second segmentation result.

The lesion identification result of the target subject may include information relating to the one or more lesion regions. Exemplary information relating to a lesion may include a size, a position, obstruction degree information, etc., of the lesion.

In some embodiments, the lesion identification result may include a segmentation image of the one or more lesion regions. In some embodiments, the lesion identification result may include a target image of the one or more arteries and the one or more lesion regions. For example, the processing device 140 may generate the target image by outlining or marking regions corresponding to the one or more arteries and the one or more lesion regions in the vascular image based on the second segmentation result.

In some embodiments, the processing device 140 may update the second segmentation result by removing false positive lesion regions from the second segmentation result, and the generate the lesion identification result based on the updated segmentation result. For example, for each of the one or more lesion regions in the second segmentation result, the processing device 140 may determine a lesion connected component corresponding to the lesion region from the vascular image based on the second segmentation result, and determine whether the lesion region is a false positive lesion region based on the lesion connected component using a lesion classification model. The lesion classification model may be a trained model (e.g., a machine learning model) used for lesion classification. Specifically, the lesion connected component may be input into the lesion classification model, and the lesion classification model may output a type of the lesion region. In some embodiments, the input of the lesion classification model may further include the vascular image and/or the second segmentation image (e.g., the lesion segmentation image). A type of the lesion region may include a false positive lesion region or a positive lesion region. In some embodiments, the lesion classification model may include a deep learning model such as a classification model. Exemplary classification models may include a decision tree model, a logistic regression model, or the like.

In response to determining that a lesion region is a false positive lesion region, the processing device 140 may remove the lesion region from the one or more lesion regions to update the second segmentation result. The processing device 140 may generate the lesion identification result of the target subject based on the updated second segmentation result obtained by removing one or more false positive lesion regions. In some embodiments, for a false positive lesion region, if the false positive lesion region is located in the one or more arteries, the processing device 140 may replace the label of the false positive lesion region with the label of the one or more arteries in the second segmentation result; if the false positive lesion region is located outside the one or more arteries, that is, the false positive lesion region is located in the background region, the processing device 140 may replace the label of the false positive lesion region with the label of the background region in the second segmentation result; if a portion (also referred to as a first portion) and the other portion (also referred to as a second portion) of the false positive lesion region is located in the one or more arteries and the background region, respectively, the processing device 140 may replace the label of the first portion with the label of the one or more arteries and replace the label of the second portion with the label of the background region in the second segmentation result.

The accuracy of the lesion identification result may be improved by removing the one or more false positive lesion regions.

In some embodiments, the obtaining of the lesion classification model may be performed in a similar manner as that of the first segmentation model described in connection with operation 420. In some embodiments, the processing device 140 may obtain a plurality of third training samples, and generate the lesion classification model by training a third preliminary model based on the plurality of third training samples. Each third training sample may include a connected component corresponding to a sample lesion region (also referred to sample connected component) in a sample image of a sample subject and a ground truth type of the sample lesion region.

In some embodiments, the ground truth type of a sample lesion region may be defined by a user or may be automatically determined by a training device. For example, the processing device 140 may determine connected components corresponding to positive lesion regions (also referred to reference connected components) of the sample subject in the sample image of the sample subject. The positive lesion regions may be located in one or more arteries of the sample subject. In some embodiments, the reference connected components may be determined based on a ground truth segmentation result of one or more arteries and one or more lesion regions of the sample subject (i.e., a training label of the second segmentation model).

Further, the processing device 140 may determine the ground truth type of the sample lesion region based on the connected components corresponding to the positive lesion regions and the connected component corresponding to the sample lesion region. Specifically, for each reference connected component, the processing device 140 may determine a coincided portion of the sample connected component that is coincided with the reference connected component. Further, the processing device 140 may determine whether a ratio of the coincided portion to a reference connected component is greater than a ratio threshold. The ratio threshold may be set manually by a user (e.g., an engineer) according to an experience value or a default setting of the medical system 100, or determined by the processing device 140 according to an actual need, such as 50%, 60%, 80%, or a larger or smaller value. In response to determining that the ratio of the coincided portion to one of the reference connected components is greater than the ratio threshold, the processing device 140 may designate that the sample lesion region is a positive lesion region. In response to determining that the ratio of the coincided portion to each of the reference connected components is not greater than the ratio threshold, the processing device 140 may designate that the sample lesion region is a false positive lesion region.

In some embodiments, the training of the lesion classification model based on the plurality of third training samples may be performed in a similar manner as that of the first preliminary model based on the plurality of first training samples as described in connection with operation 420, and the descriptions of which are not repeated here.

In some embodiments, the processing device 140 may determine information related to the one or more lesion regions based on the second segmentation result. Exemplary information relating to a lesion may include a size, a position, obstruction degree information, etc., of the lesion. Further, the processing device 140 may divide the one or more arteries into a plurality of levels of blood vessels based on the vascular image. Then, the processing device 140 may determine the lesion identification result of the target subject based on the information related to the one or more lesion regions and the plurality of levels of blood vessels. In some embodiments, the one or more arteries of the target subject may include a pulmonary artery, the one or more lesion regions may include one or more embolisms, and the lesion identification result may include a pulmonary artery obstruction index (PAOI) of the target subject. More descriptions regarding the determination of the PAOI of the target subject may be found elsewhere in the present disclosure (e.g., FIG. 6 and the descriptions thereof).

As described elsewhere in the present disclosure, the lesion identification result obtained using the conventional lesion identification approaches has a low accuracy. Compared with the conventional lesion identification approaches, the systems and methods of the present disclosure may perform two image segmentations using the first segmentation model and the second segmentation model in sequence, which may generate the second segmentation result with the improved accuracy based on the vascular image and the first segmentation result (and/or the centerline image), thereby improving the accuracy of the lesion identification result generated based on the second segmentation result. In addition, in some embodiments, the processing device 140 may remove the one or more false positive lesion regions, which may further improve the accuracy of the lesion identification result.

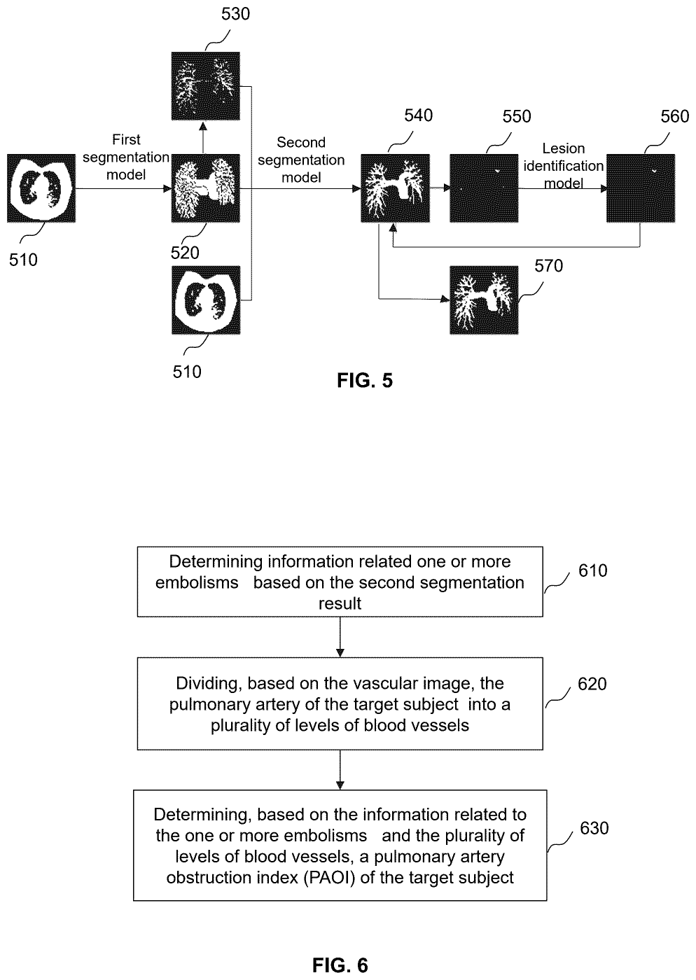

FIG. 5 is a schematic diagram illustrating an exemplary lesion identification process according to some embodiments of the present disclosure. As shown in FIG. 5, the processing device 140 may obtain a vascular image 510 of a target subject. The processing device 140 may generate a first segmentation result 520 of blood vessels of the target subject by inputting the vascular image 510 into a first segmentation model. In some embodiments, the first segmentation result may include a first segmentation image relating to the one or more arteries and the one or more veins of the target subject. The processing device 140 may generate a centerline image 530 relating to centerlines of the one or more arteries based on the first segmentation result 520. Then, the processing device 140 may generate a second segmentation result 540 of one or more arteries and one or more lesion regions of the target subject using a second segmentation model based on the first segmentation result 520, the vascular image 510, and the centerline image 530.

Further, for each of the one or more lesion regions, the processing device 140 may determine a lesion connected component 550 corresponding to the lesion region based on the second segmentation result 540, and determine whether the lesion region is a false positive lesion region based on the lesion connected component using a lesion classification model to determine one or more false positive lesion regions 560. The processing device 140 may remove the one or more false positive lesion regions 560 from the one or more lesion regions to update the second segmentation result 540, and generate the lesion identification result 570 of the target subject based on the updated second segmentation result 540.

In some embodiments, one or more arteries of the target subject include a pulmonary artery, the one or more lesion regions include one or more embolisms, and the lesion identification result includes a pulmonary artery obstruction index (PAOI) of the target subject. PAOI is an index for evaluating pulmonary embolism.

Conventionally, PAOI of a subject is manually determined by a user (e.g., a doctor) based on clinical information. Some relatively sophisticated approaches for determining PAOI cannot be widely used in clinical work due to cumbersome and complicated operating procedures. The PAOIs obtained by some simplified approaches have a low accurate. For example, the Qanadli score (PAOIQ) is usually used to evaluate pulmonary embolism. PAOIQ is a semi-quantitative parameter of the severity of pulmonary embolism and can distinguish partial and complete obstruction at the pulmonary artery trunk, the pulmonary lobe vessels, and the pulmonary segment vessels. However, the number, the position, and the obstruction degree of the embolisms are manually marked, which is time-consuming and labor-intensive. Moreover, the evaluation for the embolisms located in the pulmonary subsegment level of blood vessels is relatively crude and cannot accurately reflect the obstruction degree of pulmonary artery. Thus, it may be desirable to develop systems and methods for automated determining PAOI, thereby improving the efficiency and/or accuracy of PAOI determination. The terms “automatic” and “automated” are used interchangeably referring to methods and systems that analyze information and generates results with little or no direct human intervention.

FIG. 6 is a flowchart illustrating an exemplary process 600 for determining a pulmonary artery obstruction index (PAOI) of a target subject according to some embodiments of the present disclosure. In some embodiments, one or more operations of the process 600 may be performed to achieve at least part of operation 440 as described in connection with FIG. 4.

In 610, the processing device 140 (e.g., the third generation module 340) may determine information related one or more embolisms based on the second segmentation result.

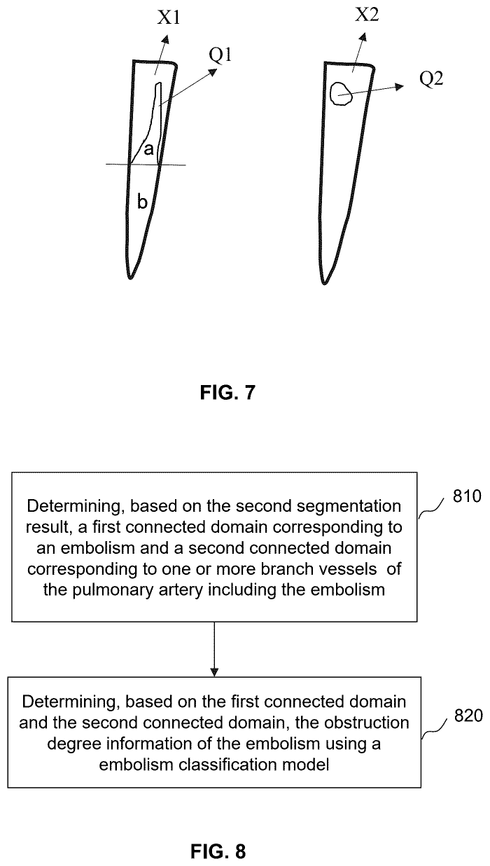

The embolisms may be exemplary lesion regions in the pulmonary artery of the target subject. Exemplary information relating to an embolism may include a size, a position information, obstruction degree information, etc., of the embolism. The position information of the embolism may indicate a position of the embolism in the pulmonary artery of the target subject. The obstruction degree information of the embolism may indicate a type of the embolism. The type of the embolism may include a non-completely occluded embolism or a completely occluded embolism. In some embodiments, if an embolism is the completely occluded embolism, blood flow cannot pass through the blood vessel at the position of the embolism. If an embolism is a non-completely occluded embolism, blood flow can pass through the blood vessel at the position of the embolism. For example, FIG. 7 is a schematic diagram illustrating exemplary embolisms according to some embodiments of the present disclosure. As shown in FIG. 7, an embolism Q1 located in a blood vessel X1 is a completely occluded embolism. An embolism Q2 located in the blood vessel X2 is a non-completely occluded embolism.

In some embodiments, for each embolism, the processing device 140 may determine the position information of the embolism based on the second segmentation result. For example, the processing device 140 may determine the position of the embolism in the pulmonary artery based on a second segmentation image of the pulmonary artery and the one or more embolisms. Merely by way of example, the processing device 140 may determine a first region corresponding to the embolism and a second region corresponding to the unobstructed portion of the pulmonary artery the in the second segmentation image, and designate the combination of the first region and the second region as a region corresponding to the pulmonary artery. Further, the processing device 140 may determine the position of the embolism based on the region corresponding to the pulmonary artery and the first region corresponding to the embolism.

In some embodiments, for each embolism, the processing device 140 may determine the obstruction degree information of the embolism based on the second segmentation result. For example, the processing device 140 may determine a first connected component corresponding to the embolism and a second connected component corresponding to one or more branch vessels of the pulmonary artery including the embolism based on the second segmentation result. Further, the processing device 140 may determine the obstruction degree information of the embolism using an embolism classification model based on the first connected component and the second connected component.

In some embodiments, a completely occluded embolism may include a non-completely occluded portion and a completely occluded portion. For example, a completely occluded embolism may be divided into a non-completely occluded portion and a completely occluded portion along a blood flow direction of the pulmonary artery. Blood flow cannot pass through the blood vessel at the position of the completely occluded portion. Blood flow can pass through the blood vessel at the position of the non-completely occluded portion. For example, the completely occluded embolism Q1 in FIG. 7 may include a non-completely occluded portion (labelled as “a”) and a completely occluded portion (labelled as “b”). In some embodiments, the obstruction degree information of the embolism may include information relating to the non-completely occluded portion and the completely occluded portion of the embolism. Accordingly, if the embolism is a completely occluded embolism, the processing device 140 may further determine a non-completely occluded portion and a completely occluded portion of the completely occluded embolism. For example, the processing device 140 may determine the non-completely occluded portion and the completely occluded portion of the completely occluded embolism using an embolism segmentation model.

More descriptions regarding the determination of the obstruction degree information of the embolism may be found elsewhere in the present disclosure (e.g., FIG. 8 and the descriptions thereof).

In 620, the processing device 140 (e.g., the third generation module 340) may divide, based on the vascular image, the pulmonary artery of the target subject into a plurality of levels of blood vessels.

In some embodiments, the plurality of levels of the pulmonary artery may be arranged from high level to low level, and include a main pulmonary artery trunk level, a left and right pulmonary artery trunk level, a pulmonary lobe level, a pulmonary segment level, a pulmonary subsegment level, etc. The main pulmonary trunk level may include a main pulmonary trunk. The left and right pulmonary artery level may include the left and right pulmonary arteries. The pulmonary lobe level may include pulmonary lobe vessels. The pulmonary segment level may include pulmonary segment vessels. The pulmonary subsegment level may include pulmonary subsegment vessels. In some embodiments, any two levels of the blood vessels do not overlap.

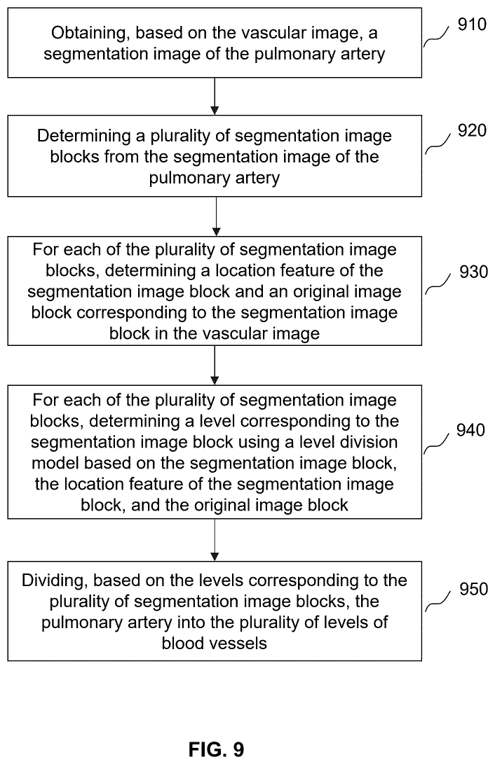

In some embodiments, the processing device 140 may obtain a segmentation image of the pulmonary artery based on the vascular image. The processing device 140 may determine a plurality of segmentation image blocks from the segmentation image of the pulmonary artery. For each of the plurality of segmentation image blocks, the processing device 140 may determine a position feature of the segmentation image block and an original image block corresponding to the segmentation image block in the vascular image, and further determine a level corresponding to the segmentation image block using a level division model based on the segmentation image block, the position feature of the segmentation image block, and the original image block. Then, the processing device 140 may divide the pulmonary artery into the plurality of levels of blood vessels based on the levels corresponding to the plurality of segmentation image blocks. More descriptions regarding the dividing of the pulmonary artery into the plurality of levels of blood vessels may be found elsewhere in the present disclosure (e.g., FIG. 9 and the descriptions thereof).

In 630, the processing device 140 (e.g., the third generation module 340) may determine, based on the information related to the one or more embolisms and the plurality of levels of blood vessels, the PAOI of the target subject.

In some embodiments, for each of the one or more embolisms, the processing device 140 may determine a second connected component corresponding to one or more branch vessels of the pulmonary artery including the embolism based on the information related to the embolism, and divide the one or more second connected components of the one or more embolisms into a plurality of regions. Further, for each of the plurality of regions, the processing device 140 may determine an embolism burden score of the region based on the information related to one or more embolisms located in the region and the level of blood vessels included in the region. Then, the processing device 140 may determine the PAOI of the target subject based on the embolism burden scores of the plurality of regions.

In some embodiments, for each of the one or more embolisms, the processing device 140 may determine a second connected component corresponding to one or more branch vessels of the pulmonary artery including the embolism from the vascular image based on the information related to the embolism and the second segmentation result. Specifically, the processing device 140 may determine the one or more branch vessels of the pulmonary artery including the embolism based on the position information of the embolism. Further, the processing device 140 may determine the second connected component corresponding to the one or more branch vessels from the vascular image and the second segmentation result.

Further, the processing device 140 may divide the one or more second connected components of the one or more embolisms into a plurality of regions. Each region may include the same level of blood vessels, and the plurality of regions do not overlap. For each of the plurality of regions, the processing device 140 may determine an embolism burden score of the region based on the information related to one or more embolisms located in the region and the level of blood vessels included in the region. In some embodiments, the processing device 140 may determine the embolism burden score of the region based on the position information and obstruction degree information of the one or more embolisms located in the region, and the level of blood vessels included in the region. Merly by way of example, the processing device 140 may determine an embolism burden score of the region according to Equation (1):

$${CBS}_{i} = n * w * d , \qquad ( 1 )$$

where, i denotes a positive integer indicating a serial number of the region, CBSᵢ denotes the embolism burden score of the ith region, n denotes a score of the position of the ith region, d denotes a score of an obstruction degree of the one or more embolisms located in the ith region, w denotes a score of an overall impact on the pulmonary artery when the ith region include one or more embolisms. Specifically, n may be determined based on the position information of the one or more embolisms. If there is no embolism in the ith region, n may be 0; if there are one or more embolisms in the ith region and the level corresponding to the blood vessels included in the ith region are at the pulmonary segment level or above (that is, other levels other than the pulmonary subsegment level), n may be a number of pulmonary segment vessels in the ith region; if there are one or more embolisms in the ith region and the level corresponding to the blood vessels included in the ith region is the pulmonary subsegment level, n may be a number of pulmonary segment vessels to which the pulmonary subsegmental vessels belong. For example, if the blood vessels in the ith region are the main pulmonary artery trunk vessel and the number of branch vessels of the main pulmonary artery trunk vessel is 20, n may be 20. As another example, if the ith region includes three pulmonary subsegment vessels belonging to the same pulmonary segment vessel, n may be 1.

In some embodiments, w may be set based on clinical needs and validation results. When an embolism is located at different levels of blood vessels, effects of the embolism on the pulmonary artery may be different. The impact of the embolism on the pulmonary artery may be greater if the embolism is located at a higher level of blood vessels, and w may be larger. The impact of the embolism on the pulmonary artery may be the smaller if the embolism is located at a lower level of blood vessels, and w may be smaller. For example, when the embolism is located at the level higher than the pulmonary segment level, w may be 1; when the embolism is located in the pulmonary segment level, w may be ½; when the embolism is located in pulmonary subsegment level, w may be ¼.

In some embodiments, d may be determined according to the obstruction degree information of the one or more embolisms. The value of d when the ith region include a completely occluded embolism or a completely occluded portion of a completely occluded embolism may be greater than the value of d when the ith region include a non-completely occluded embolism or a non-completely occluded portion of a completely occluded embolism. For example, if the ith region includes a completely occluded embolism or a completely occluded portion of a completely occluded embolism, d may be 2; if the ith region only includes one or more non-completely occluded embolisms or non-completely occluded portions of one or more completely occluded embolisms, that is, the ith region does not include a completely occluded embolism or a completely occluded portion of a completely occluded embolism, d may be 1.

Then, the processing device 140 may determine the PAOI of the target subject based on the embolism burden scores of the plurality of regions. For example, the processing device 140 may determine the PAOI of the target subject according to Equation (2):

$$PAOI = \frac{CBS}{40} * 100 \% , \qquad ( 2 )$$

where, CBS denotes a total embolism burden score determined based on the embolism burden scores, and 40 is the maximum value of the embolism burden score.

In some embodiments, the processing device 140 may combine the embolism burden scores of the plurality of regions to obtain the total embolism burden score of the target subject. For example, the processing device 140 may determine one or more target embolism burden scores from the embolism burden scores of the plurality of regions, and then designate a sum of the one or more target embolism burden as a total embolism burden score. Merely by way of example, the regions may be arranged according to the levels of the blood vessels where they located in a descending order. If there are one or more embolisms in a region A located at a high level of blood vessels (also referred to as a target level), the processing device 140 may determine the embolism burden score of the region A as the target embolism burden score, and exclude embolism burden scores of regions located at the branch vessels of the target level of blood vessels (that is, the embolism burden scores of regions located at the branch vessels of the target level of blood vessels are not used as target embolism burden scores).

For example, if there are embolisms located at the main pulmonary trunk vessel and one pulmonary lobe vessel, the processing device 140 may determine that the one or more target embolism burden scores include the embolism burden score of the main pulmonary trunk vessel, and the total embolism burden score is the embolism burden score of the main pulmonary trunk vessel. As another example, if there are embolisms located at the left pulmonary artery and all pulmonary segment vessels in the left pulmonary artery, the processing device 140 may determine that the one or more target embolism burden scores include the embolism burden score of the left pulmonary artery, and the total embolism burden score is the embolism burden score of the left pulmonary artery. As still another example, if there are embolisms located at the left pulmonary artery and two right pulmonary segment vessels (the two right pulmonary segment vessels are not branch vessels of the left pulmonary artery), the processing device 140 may determine that the one or more target embolism burden scores include the embolism burden scores of these three regions, and the total embolism burden score is a sum of the embolism burden scores of these three regions.

Compared with the conventional PAOI determination approaches which involve a lot of human intervention, the systems and methods of the present disclosure may be automatically implemented with reduced or minimal or without user intervention, which is more efficient and accurate by, e.g., reducing the workload of a user, cross-user variations, and the time needed for the PAOI determination. Moreover, the systems and methods of the present disclosure may be relatively simple, thereby having high clinical practicability. In addition, the accuracy of the PAOI may be further improved by optimizing the calculation strategy of the embolism burden score of each region. In some embodiments, a completely occluded embolism may be further divided into a completely occluded portion and a non-completely occluded portion. The score of the obstruction degree of the completely occluded embolism on a region may be further determined according to whether a portion of the completely occluded embolism located in the region is a completely occluded portion or a non-completely occluded portion, which may improve the accuracy of the score of the obstruction degree, thereby improving the accuracy of the embolism burden score and the PAOI.

It should be understood that process 600 can also be used to determine other lesion identification results of the embolisms or lesion identification results of other lesions.

FIG. 8 is a flowchart illustrating an exemplary process 800 for determining obstruction degree information according to some embodiments of the present disclosure. In some embodiments, one or more operations of the process 800 may be performed to achieve at least part of operation 610 as described in connection with FIG. 6. The process 800 may be performed for each embolism, and the implementation of the process 800 for one embolism is described hereinafter.

In 810, the processing device 140 (e.g., the third generation module 340) may determine, based on the second segmentation result, a first connected component corresponding to an embolism and a second connected component corresponding to one or more branch vessels of the pulmonary artery including the embolism.

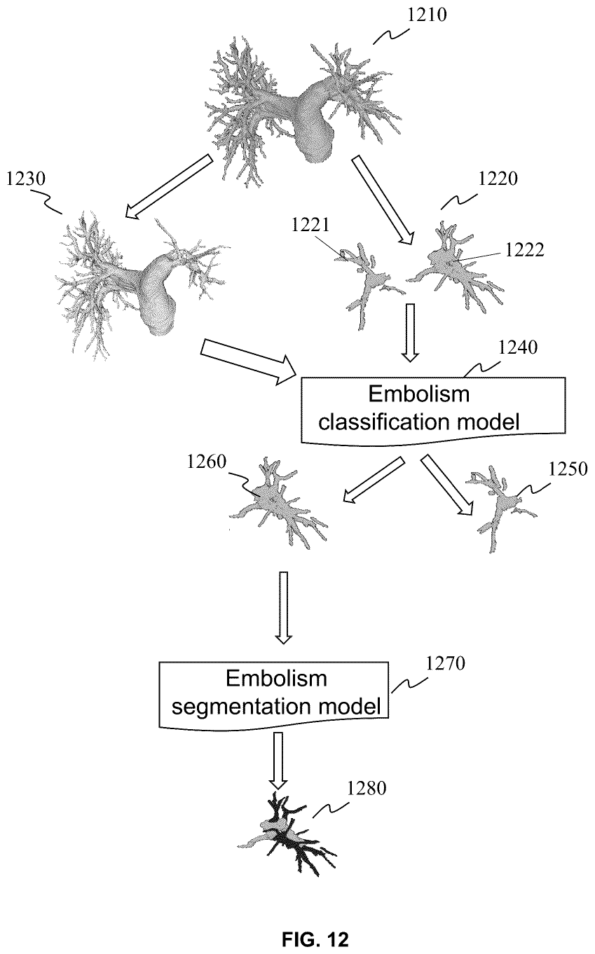

As used herein, the first connected component of an embolism refers to a connected region including the embolism in the vascular image. A second connected component corresponding to one or more branch vessels refers to a connected region including the one or more branch vessels in the vascular image. As shown in FIG. 12, connected components of two embolisms 1221 and 1222 may be obtained based on the second segmentation result. In some embodiments, the processing device 140 may determine the first connected component and the second connected component using a connected component extraction technology (e.g., a pixel-by-pixel comparison algorithm).

In some embodiments, the processing device 140 may determine the one or more branch vessels based on the second segmentation result. For example, the processing device 140 may directly segment the portion of the pulmonary artery including the embolism to obtain the one or more branch vessels based on the second segmentation result.

In 820, the processing device 140 (e.g., the third generation module 340) may determine, based on the first connected component and the second connected component, the obstruction degree information of the embolism using an embolism classification model.

In some embodiments, as described in operation 610, the obstruction degree information of the embolism may include the type of the embolism. The type of embolism may include a complete occluded embolism or a non-complete occluded embolism. The embolism classification model may be a model (e.g., a machine leaning model) for determining a type of an embolism. Specifically, the first connected component and the second connected component may be input into the embolism classification model, and the embolism classification model may output the type of the embolism.

In some embodiments, the embolism classification model may include a deep learning model, a traditional machine learning model, etc. Exemplary traditional machine learning models may include a logistic regression model, a decision tree model, a naive Bayes model, a support vector machine model, or the like, or any combination thereof.

In some embodiments, an optimal size of an image block processed by the embolism classification model is pre-designed. When a size of an image block input into the embolism classification model does not match the optimal size, the embolism classification model automatically adjusts the size of the image block, which may lead to a distortion of the adjusted image block, thereby reducing the accuracy of an output result of the embolism classification model. In some embodiments, the processing device 140 may resample the first connected component and the second connected component, and input the resampled the first connected component and the second connected component into the embolism classification model to obtain the type of the embolism.

In some embodiments, the processing device 140 may determine resampling ratios based on a smallest bounding box of the first connected component, and resample the first connected component and the second connected component based on the resampling ratios to obtain a resampled first connected component and a resampled second connected component. Further, the processing device 140 may determine the obstruction degree information of the embolism using the embolism classification mode based on the resampled first connected component and the resampled second connected component.

As used herein, a resampling ratio refers to a resampling ratio in a resampling direction, that is, each resampling ratio corresponds to a resampling direction (e.g., a direction parallel to a side of the smallest bounding box of the first connected component). In some embodiments, the processing device 140 may determine the resampling ratios in a plurality of resampling directions based on a length and a physical resolution of the longest side of the smallest bounding box of the first connected component. The resampling ratios in the plurality of resampling directions may be the same or different. For example, the processing device 140 may determine the resampling ratios in the length direction, the width direction, and the height direction of the smallest bounding box according to equation (3) as below:

$${R}_{L} = {R}_{W} = {R}_{H} = \frac{N * ( 1 + 2 Pad ) / {S}_{N}}{X} , \qquad ( 3 )$$

where R_{L}, R_{W}, and R_{H} denote the resampling ratios in the length direction, the width direction, and the height direction of the smallest bounding box, respectively, N denotes the length of the longest side of the smallest bounding box, S_{N} denotes the physical resolution of the longest side of the smallest bounding box, Pad denotes a default bounding box filling rate, X denotes the pre-designed optimal sizes of the image block in the length direction, the width direction, and the height direction.

Conventional resampling approaches determine the resampling ratios in the length direction, the width direction, and the height direction according to Equations (4)-(6) as blow:

$${R}_{L} = \frac{L * ( 1 + 2 Pad ) / {S}_{L}}{X} , \qquad ( 4 )$$

$${R}_{W} = \frac{W * ( 1 + 2 Pad ) / {S}_{W}}{X} , \qquad ( 5 )$$

$${R}_{H} = \frac{H * ( 1 + 2 Pad ) / {S}_{H}}{X} , \qquad ( 6 )$$

However, since the embolism blocks the pulmonary artery along the blood flow direction in the pulmonary artery, the sizes of the embolism in different directions usually vary greatly and the embolism is generally distributed in a long strip. The conventional resampling approaches lead to that deformation proportions of the resampled image block in different directions are different, which results in the distortion of the image block, thereby reducing the accuracy of the output result of the embolism classification model. According to the resampling method of the present disclosure, the deformation proportions of the resampled image block in different directions are the same, which may avoid the distortion of the image block, thereby improving the accuracy of the output result of the embolism classification model.

In some embodiments, the obtaining of the embolism classification model may be performed in a similar manner as that of the first segmentation model described in connection with operation 420. In some embodiments, the embolism classification model may be generated according to a machine learning algorithm. Merely by way of example, the processing device 140 may obtain a plurality of fourth training samples, and generate the embolism classification model by training a fourth preliminary model based on the plurality of fourth training samples. Each fourth training sample may include a sample first connected component of a sample embolism located in a pulmonary artery of a sample subject, a sample second connected component corresponding to one or more branch vessels of the pulmonary artery including the embolism, and a ground truth type of the sample embolism, wherein, the ground truth type of the sample embolism can be used as the label (or ground truth) for model training. In some embodiments, ground truth type of the sample embolism may be manually determined by a user. In some embodiments, the above resampling operation may be performed on the sample first connected component and the sample second connected component in each fourth training sample to obtain the resampled sample first connected component and the resampled sample second connected component, and the resampled sample first connected component and the resampled sample second connected component may be used for model training.

As described in operation 620, a completely occluded embolism may include a non-completely occluded portion and a completely occluded portion. In some embodiments, if the embolism is the completely occluded embolism, the obstruction degree information of the embolism may include information relating to the non-completely occluded portion and the completely occluded portion of the embolism.

In some embodiments, in response to determining that the one or more embolisms include one or more completely occluded embolisms, for each of the one or more completely occluded embolisms, the processing device 140 may determine a non-completely occluded portion and a completely occluded portion of the completely occluded embolism using an embolism segmentation model based on the first connected component corresponding to the completely occluded embolism and the second connected component corresponding to one or more branch vessels of the pulmonary artery including the completely occluded embolism.

The embolism segmentation model may be a trained model (e.g., a machine learning model) for segmenting completely occluded embolism. Specifically, the first connected component corresponding to the completely occluded embolism and the second connected component corresponding to the one or more branch vessels of the pulmonary artery including the completely occluded embolism may be input into the embolism segmentation model, and the embolism segmentation model may output a segmentation image relating to the non-completely occluded portion and the completely occluded portion of the completely occluded embolism. For example, the first connected component corresponding to the completely occluded embolism Q1 shown in FIG. 7 and the second connected component corresponding to one or more branch vessels of the pulmonary artery including the completely occluded embolism Q1 may be input into the embolism segmentation model, and the embolism segmentation model may output a segmentation image of the non-completely occluded portion a and the completely occluded portion b of the completely occluded embolism Q1.

In some embodiments, the embolism segmentation model may include any model as described elsewhere in the present disclosure (e.g., operation 420). In some embodiments, the obtaining of the embolism segmentation model may be performed in a similar manner as that of the first segmentation model described in connection with operation 420. In some embodiments, the embolism segmentation model may be generated according to a machine learning algorithm. Merely by way of example, the processing device 140 may obtain a plurality of fifth training samples, and generate the embolism segmentation model by training a fifth preliminary model based on the plurality of fifth training samples. Each fifth training sample may include a sample first connected component of a sample completely occluded embolism located in a pulmonary artery of a sample subject, a sample second connected component corresponding to one or more branch vessels of the pulmonary artery including the completely occluded embolism, and a ground truth segmentation image of the non-completely occluded portion and the completely occluded portion of the sample completely occluded embolism, wherein the ground truth segmentation image can be used as the label (or ground truth) for model training. In some embodiments, the ground truth segmentation image of the non-completely occluded portion and the completely occluded portion may be manually determined by a user.

FIG. 9 is a flowchart illustrating an exemplary process 900 for pulmonary artery division according to some embodiments of the present disclosure. In some embodiments, one or more operations of the process 900 may be performed to achieve at least part of operation 620 as described in connection with FIG. 6.

In 910, the processing device 140 (e.g., the third generation module 340) may obtain, based on the vascular image, a segmentation image of the pulmonary artery of the target subject.

In some embodiments, the segmentation image of the pulmonary artery may indicate the pulmonary artery of the target subject segmented from the vascular image. In some embodiments, the segmentation image of the pulmonary artery may be the complete artery segmentation image described in operation 430. In some embodiments, the processing device 140 may obtain the segmentation image of the pulmonary artery based on the second segmentation image generated in operation 430. For example, the processing device 140 may set the other region other than the background region in the second segmentation image with the same label (i.e., a label corresponding to the pulmonary artery) to obtain the segmentation image of the pulmonary artery.

In 920, the processing device 140 (e.g., the third generation module 340) may determine a plurality of segmentation image blocks from the segmentation image of the pulmonary artery.

A segmentation image block includes at least a portion of the pulmonary artery. In some embodiments, the processing device 140 may extract a centerline of the pulmonary artery from the segmentation image. Further, the processing device 140 may select a starting point on the centerline (e.g., an end point or a middle point of the centerline) of the pulmonary artery, and determine the segmentation image blocks in the segmentation image along the centerline with a preset size starting from the starting point. In some embodiments, center points of at least part of the segmentation image blocks may be located on the centerline of the pulmonary artery to ensure that a proportion of the pulmonary artery in the segmentation image blocks may be relatively high. In some embodiments, some adjacent segmentation image blocks may partially overlap to ensure that the segmentation image blocks cover the pulmonary artery.

In 930, for each of the plurality of segmentation image blocks, the processing device 140 (e.g., the third generation module 340) may determine a position feature of the segmentation image block and an original image block corresponding to the segmentation image block in the vascular image.

In some embodiments, the processing device 140 may determine the original image block corresponding to the segmentation image block in the vascular image based on a correspondence relationship between elements of the vascular image and the segmentation image of the pulmonary artery.

The position feature of a segmentation image block may indicate a position of the segmentation image block in the entire pulmonary artery. For example, the position feature of the segmentation image block may indicate a relative position of a center point of the segmentation image block relative to an edge of the pulmonary artery. In some embodiments, the processing device 140 may determine the position feature of the segmentation image block based on a world coordinate of the center point of the segmentation image block. For example, the processing device 140 may determine the position feature of the segmentation image block in three coordinate axes of a world coordinate system according to Equation (7):

$$t = ( {p}_{w}^{i} - {c}_{min}^{i} ) / ( {c}_{max}^{i} - {c}_{min}^{i} ) , \qquad ( 7 )$$

where, i denotes a coordinate axis of the world coordinate system, i∈{x, y, z}, p_{w}ⁱ denotes the coordinate of the center point of the segmentation image block in coordinate axis i, cₘᵢₙⁱ and cₘₐₓⁱ denote the coordinates of two diagonal voxels of the smallest bounding box including the pulmonary artery, which can be used to determine the smallest bounding box including the pulmonary artery. For example, cₘᵢₙⁱ denotes the coordinate (0, 0, 0) of the smallest voxel of the smallest bounding box including the pulmonary artery, and cₘₐₓⁱ denotes the coordinate (h, w, d) of the largest voxel of the smallest bounding box including the pulmonary artery, wherein h, w, d denotes the length, the width, and the height of the smallest bounding box.

In 940, for each of the plurality of segmentation image blocks, the processing device 140 (e.g., the third generation module 340) may determine a level corresponding to the segmentation image block using a level division model based on the segmentation image block, the position feature of the segmentation image block, and the original image block.

In some embodiments, the level division model may be a trained model (e.g., a machine learning model) for determining a level of a blood vessel where a segmentation image block is located (also referred to as a level of a segmentation image block). Specifically, the segmentation image block, the position feature of the segmentation image block, and the original image block may be input into the level division model, and the level division model may output the level of the segmentation image block. In some embodiments, the plurality of segmentation image blocks, the position feature of each segmentation image block, and the original image blocks corresponding to the plurality of segmentation image blocks may be input into the level division model together, and the level division model may output the level of each segmentation image block.

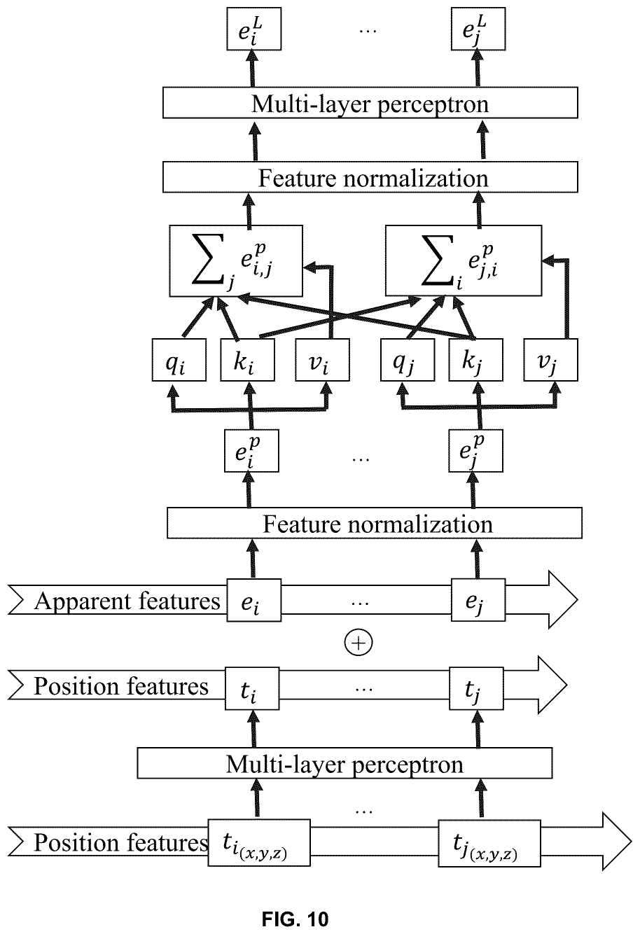

In some embodiments, the level division model may include a convolutional neural network (CNN), a transformer model, and a decoder. The CNN may be configured to extract apparent features of an image block. The segmentation image block and the original image block may be input into the CNN, and the CNN may extract apparent features (e.g., apparent features eᵢ and eⱼ in FIG. 10) of the segmentation image block and the original image block. An amount of apparent features may be related to the design of the CNN. In some embodiments, the apparent features may be a one-dimensional vector. Using the CNN to extract apparent features of image blocks may reduce the dimension of apparent feature information, which may extract the apparent features that satisfy requirements and reduce network parameters, thereby improving the computational efficiency of the model.

The transformer model may be configured to fuse the apparent features and the positional features of image blocks to obtain the fused image block features. Specifically, the apparent features of the segmentation image blocks and the original image blocks, and the positional features of the segmentation image blocks may be input to the transformer model, and the transformer model may output the fused image block features.

For example, a transformer model may be stacked by multiple same layers, and each layer may include an encoder module and a decoder module. The encoder module may be used to extract features of image blocks to generate a key vector and a value vector. The decoder module may be used to generate a query vector. Both the encoder module and the decoder module include self-attention layers and feed-forward neural networks. The feedforward neural networks may be linear transformation layers and nonlinear activation function layers that perform feature mapping other than the self-attention layers. The decoder module may include an additional encoder-decoder attention layer between the self-attention layers and the feedforward neural networks, which is used to introduce the key vectors and the value vectors of the corresponding layers of the decoder module, and its attention mechanism focuses on interrelationships between different image blocks. In a self-attention layer, an apparent feature vector may be transformed into a query vector, a key vector, and a value vector with the same dimension. The self-attention layer uses an attention function to map the apparent feature vector into matrices representing the query vector, the key vector, and the value vector. The attention function may be calculated by Equation (8):

$$Attention ( Q , K , V ) = soft max ( \frac{Q \cdot {K}^{T}}{\sqrt{d}} ) \cdot V , \qquad ( 8 )$$

where, Attention denotes the attention function, Q denotes the matrix representing the query vector, K denotes the matrix representing the key vector, T denotes the matrix transpose, V denotes the matrix representing the value vector, and d denotes the dimension of the query vector, the key vector, or the value vector.

Since the self-attention layer do not capture the position information of the image blocks. In order to solve this problem, in some embodiments, the positional features may be embedded into the apparent feature vectors using a multi-layer perceptron. Further, the apparent feature vectors embedding positional features may be input into the transformer model, and the transformer model may output the fused image block features.

For example, FIG. 10 is a schematic diagram illustrating an exemplary process for determining features of fused image blocks according to some embodiments of the present disclosure. As shown in FIG. 10, the position features of each segmentation image block in three axes x, y, and z may be fused via the multi-layer perceptron to obtain the position feature of the segmentation image block. For example, the position features tᵢ_{_{(x,y,z)}} of the segmentation image block i on the three axes x, y, and z may be fused through the multi-layer perceptron to obtain the position feature tᵢ of the segmentation image block i, and the position features tᵢ of the segmentation image block j on the three axes x, y, and z may be fused through the multi-layer perceptron to obtain the position feature tᵢ of the segmentation image block j. Then, the position feature of each segmentation image block may be summed with the corresponding apparent feature vector, and feature normalization may be performed on the summed feature to obtain the apparent feature vector embedding the positional feature. For example, the positional feature tᵢ of the segmentation image block i may be added to the corresponding apparent feature vector eᵢ, and the apparent feature vector eᵢ^{p} embedding the positional feature may be obtained through performing the feature normalization on the summed feature. The specific expression may be eᵢ^{p}=Norm(eᵢ⊕MLP (tᵢ_{_{(x,y,z)}}), wherein ⊕ denotes a matrix addition, MLP denotes the multi-layer perceptron, and Norm denotes the feature normalization.

Furthermore, the apparent feature vectors eᵢ^{p}−eⱼ^{p} embedding position features may be input into the transformer model. The transformer model may convert each apparent feature vector into a query vector q, a key vector k and a value vector v, then obtain the attention of each apparent feature vector by combining the key vectors k of different image blocks, perform the feature normalization on the attention, and input the normalized attention into the multi-layer perceptron to output the fused image block feature eᵢ^{L}−eⱼ^{L}. For example, as shown in FIG. 10, the transformer model may determine the attention Σⱼ e_{i,j}^{p} of eᵢ^{p} based on the query vector qᵢ, the key vector kᵢ, the value vector vi of the apparent feature vector eᵢ^{p}, and the key vectors of other apparent feature vectors (e.g., kⱼ of the apparent feature vector eⱼ^{p}). Similarly, the transformer models may obtain attentions of other apparent feature vectors (e.g., Σᵢe_{j,i}^{p}). Further, feature normalization may be performed on the attentions Σⱼe_{i,j}^{p}−Σᵢe_{j,i}^{p}, the normalized attentions may be input into the multi-layer perceptron, and the multi-layer perceptron may output the fused image block features eᵢ^{L}−eⱼ^{L}.

The decoder may be configured to convert the fused image block features output by the transformer model into level division results of segmentation image blocks. Specifically, the fused image block features output by the transformer model may be input to the decoder, and the decoder may output the level division results of each segmentation image block. The level division result of the segmentation image block may indicate the level corresponding to the segmentation image block.

According to some embodiments of the present disclosure, the transformer model may comprehensively consider the relationship between different segmentation image blocks through a self-attention mechanism to ensure the continuity of the pulmonary artery, and may improve the accuracy of the levels of segmentation image blocks by embedding position features into the apparent features of the image blocks.

In 950, the processing device 140 (e.g., the third generation module 340) may divide, based on the levels corresponding to the plurality of segmentation image blocks, the pulmonary artery into the plurality of levels of blood vessels.

As described in operation 620, the plurality of levels of the pulmonary artery may be arranged from high level to low level, and include a main pulmonary trunk level, a left and right pulmonary artery level, a pulmonary lobe level, a pulmonary segment level, a pulmonary subsegment level, etc. The processing device 140 may divide the pulmonary artery into the plurality of levels of blood vessels according to the level of each segmentation image block.

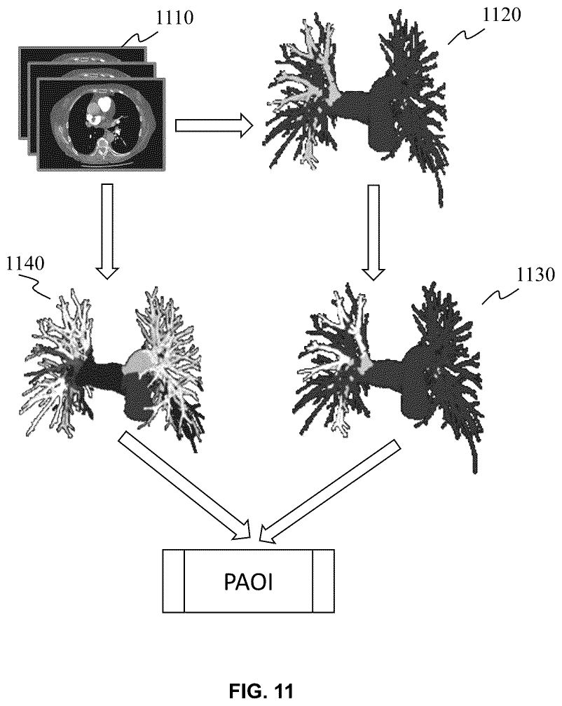

FIG. 11 is a schematic diagram illustrating an exemplary process for determining a PAOI of a target subject according to some embodiments of the present disclosure. As shown in FIG. 11, the processing device 140 may generate a second segmentation result 1120 based on a vascular image 1110, wherein a gray part in the second segmentation result 1120 represents one or more embolisms, and a black part represents a portion of a pulmonary artery of the target subject other than the one or more embolisms (i.e., an unobstructed part of the pulmonary artery).

The processing device 140 may determine information related to the one or more embolisms based on the second segmentation result 1120. For example, the processing device 140 may determine the obstruction degree information 1130 related to the one or more embolisms based on the second segmentation result 1120. Specifically, FIG. 12 is a schematic diagram illustrating an exemplary process for determining obstruction degree information of one or more embolisms according to some embodiments of the present disclosure. The vascular image 1110 may be input into the first segmentation model, and the first segmentation model may output a first segmentation image 1210 of the pulmonary artery as shown in FIG. 12. The first segmentation image 1210 and the vascular image 1110 may be input into the second segmentation model, the second segmentation model may output a lesion segmentation image 1220 showing the one or more embolisms in the pulmonary artery and an unobstructed artery segmentation image 1230 showing the unobstructed portion of pulmonary artery. The processing device 140 may determine a complete occluded embolism 1260 and a non-complete occluded embolism 1250 using an embolism classification model 1240 based on the lesion segmentation image 1220 and the unobstructed artery segmentation image 1230. Further, processing device 140 may determine a completely occluded portion and a non-completely occluded portion of the completely occluded embolism 1260 using an embolism segmentation model 1270. As shown in FIG. 12, a black area in 1280 represents the completely occluded portion of the completely occluded embolism 1260, and a gray area represents the non-completely occluded portion of the completely occluded embolism 1260.

Referring to FIG. 11 again, the processing device 140 may divide the pulmonary artery into the plurality of levels of blood vessels 1140 based on the vascular image 1110. Further, the processing device 140 may determine the PAOI of the target subject based on the obstruction degree information 1130 and the plurality of levels of blood vessels 1140.

It should be noted that the processes 400, 600, 800, and 900, and the descriptions thereof are provided for the purposes of illustration, and not intended to limit the scope of the present disclosure. For persons having ordinary skills in the art, various modifications and changes in the forms and details of the application of the above method and system may occur without departing from the principles of the present disclosure. However, those variations and modifications also fall within the scope of the present disclosure. For example, the operations of the illustrated processes 400, 600, 800, and 900 are intended to be illustrative. In some embodiments, the processes 400, 600, 800, and 900 may be accomplished with one or more additional operations not described, and/or without one or more of the operations discussed. Additionally, the order in which the operations of the processes 400, 600, 800, and 900 and regarding descriptions are not intended to be limiting.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an subject oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate a certain variation (e.g., +1%, +5%, +10%, or ±20%) of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable. In some embodiments, a classification condition used in classification or determination is provided for illustration purposes and modified according to different situations. For example, a classification condition that “a value is greater than the threshold value” may further include or exclude a condition that “the probability value is equal to the threshold value.”

What is claimed is:

1. A system for lesion identification, comprising:
at least one storage device including a set of instructions; and
at least one processor in communication with the at least one storage device, wherein when executing the set of instructions, the at least one processor is configured to direct the system to perform operations including:
obtaining a vascular image of a target subject;
generating a first segmentation result of blood vessels of the target subject based on the vascular image;
generating a second segmentation result of one or more arteries and one or more lesion regions of the target subject based on the first segmentation result and the vascular image using; and
generating a lesion identification result of the target subject based on the second segmentation result.

2. The system of claim 1, wherein the first segmentation result includes a first segmentation image relating to the one or more arteries and one or more veins of the target subject.

3. The system of claim 2, wherein regions corresponding to the one or more arteries and the one or more veins are expended in the first segmentation image.

4. The system of claim 1, wherein the generating a second segmentation result of one or more arteries and one or more lesion regions of the target subject based on the first segmentation result and the vascular image includes:
generating, based on the first segmentation result, a centerline image relating to centerlines of the one or more arteries; and
generating the second segmentation result based on the first segmentation result, the vascular image, and the centerline image.

5. The system of claim 1, wherein the first segmentation result is generated using a first segmentation model, and the second segmentation result is generated using a second segmentation model.

6. The system of claim 5, wherein the first segmentation model is generated by a training process including:
obtaining a plurality of first training samples, wherein each of the plurality of first training samples includes a sample vascular image of a sample subject and a ground truth segmentation result relating to one or more arteries and one or more veins of the sample subject; and
generating the first segmentation model by training a first preliminary model based on the plurality of first training samples.

7. The system of claim 5, wherein the second segmentation model is generated by a training process including:
obtaining a plurality of second training samples, wherein each of the plurality of second training samples includes a sample vascular image of a sample subject, a sample first segmentation result, and a ground truth segmentation result of one or more arteries and one or more lesion regions of the sample subject, wherein the sample first segmentation result is obtained by inputting the sample vascular image into the first segmentation model; and
generating the second segmentation model by training a second preliminary model based on the plurality of second training samples.

8. The system of claim 1, wherein the generating a lesion identification result of the target subject based on the second segmentation result includes:
for each of the one or more lesion regions,
determining, from the vascular image, a lesion connected component corresponding to the lesion region based on the second segmentation result;
determining whether the lesion region is a false positive lesion region based on the lesion connected component using a lesion classification model;
in response to determining that the lesion region is a false positive lesion region, removing the lesion region from the one or more lesion regions to update the second segmentation result; and
generating, based on the updated second segmentation result obtained by removing one or more false positive lesion regions, the lesion identification result of the target subject.

9. The system of claim 8, wherein the lesion classification model is generated by a training process including:
obtaining a plurality of third training samples, wherein each of the plurality of third training samples includes a connected component corresponding to a sample lesion region in a sample image of a sample subject and a ground truth type of the sample lesion region; and
generating the lesion classification model by training a third preliminary model based on the plurality of third training samples, wherein, the ground truth type of the sample lesion region is determined by:
determining, in the sample image of the sample subject, connected components corresponding to positive lesion regions of the sample subject;
determining, based on the connected components corresponding to the positive lesion regions and the connected component corresponding to the sample lesion region, the ground truth type of the sample lesion region.

10. The system of claim 1, wherein the generating a lesion identification result of the target subject based on the second segmentation result includes:
determining information related to the one or more lesion regions based on the second segmentation result;
dividing, based on the vascular image, the one or more arteries into a plurality of levels of blood vessels; and
determining, based on the information related to the one or more lesion regions and the plurality of levels of blood vessels, the lesion identification result of the target subject.

11. The system of claim 10, wherein the one or more arteries of the target subject include a pulmonary artery, the one or more lesion regions include one or more embolisms, and the lesion identification result includes a pulmonary artery obstruction index (PAOI) of the target subject.

12. The system of claim 11, wherein the information related to the one or more lesion regions includes obstruction degree information of each of the one or more embolisms, and the determining information related to the one or more embolisms based on the second segmentation result includes:
for each of the one or more embolisms,
determining, based on the second segmentation result, a first connected component corresponding to the embolism and a second connected component corresponding to one or more branch vessels of the pulmonary artery including the embolism; and
determining, based on the first connected component and the second connected component, the obstruction degree information of the embolism using an embolism classification model.

13. The system of claim 12, wherein the determining, based on the first connected component and the second connected component, the obstruction degree information of the embolism using an embolism classification mode includes:
determining, based on a smallest bounding box of the first connected component, resampling ratios;
resampling the first connected component and the second connected component based on the resampling ratios to obtain a resampled first connected component and a resampled second connected component; and
determining, based on the resampled first connected component and the resampled second connected component, the obstruction degree information of the embolism using the embolism classification mode.

14. The system of claim 12, wherein the obstruction degree information of each of the one or more embolisms indicates whether the embolism is a non-completely occluded embolism or a completely occluded embolism, and the operations further include:
in response to determining that the one or more embolisms include one or more completely occluded embolisms,
for each of the one or more completely occluded embolisms, determining, based on the first connected component corresponding to the completely occluded embolism and the second connected component corresponding to one or more branch vessels of the pulmonary artery including the completely occluded embolism, a non-completely occluded portion and a completely occluded portion of the completely occluded embolism using an embolism segmentation model.

15. The system of claim 11, wherein the pulmonary artery is divided into the plurality of levels of blood vessels by:
obtaining, based on the vascular image, a segmentation image of the pulmonary artery;
determining a plurality of segmentation image blocks from the segmentation image of the pulmonary artery;
for each of the plurality of segmentation image blocks,
determining a location feature of the segmentation image block and an original image block corresponding to the segmentation image block in the vascular image;
determining a level corresponding to the segmentation image block using a level division model based on the segmentation image block, the location feature of the segmentation image block, and the original image block; and
dividing, based on the levels corresponding to the plurality of segmentation image blocks, the pulmonary artery into the plurality of levels of blood vessels.

16. The system of claim 11, wherein the PAOI of the target subject is determined by:
for each of the one or more embolisms, determining, based on the information related to the embolism, a second connected component corresponding to one or more branch vessels of the pulmonary artery including the embolism;
dividing the one or more second connected components of the one or more embolisms into a plurality of regions;
for each of the plurality of regions, determining an embolism burden score of the region based on the information related to one or more embolisms located in the region and the level of blood vessels included in the region; and
determining the PAOI of the target subject based on the embolism burden scores of the plurality of regions.

17. A method for lesion identification, the method being implemented on a computing device having at least one storage device and at least one processor, the method comprising:
obtaining a vascular image of a target subject;
generating a first segmentation result of blood vessels of the target subject based on the vascular image;
generating a second segmentation result of one or more arteries and one or more lesion regions of the target subject based on the first segmentation result and the vascular image; and
generating a lesion identification result of the target subject based on the second segmentation result.

18. The method of claim 17, wherein the first segmentation result includes a first segmentation image relating to the one or more arteries and one or more veins of the target subject.

19. The method of claim 18, wherein regions corresponding to the one or more arteries and the one or more veins are expended in the first segmentation image.

20. A non-transitory computer readable medium, comprising at least one set of instructions, wherein when executed by one or more processors of a computing device, the at least one set of instructions causes the computing device to perform a method, the method comprising:
obtaining a vascular image of a target subject;
generating a first segmentation result of blood vessels of the target subject based on the vascular image;
generating a second segmentation result of one or more arteries and one or more lesion regions of the target subject based on the first segmentation result and the vascular image; and
generating a lesion identification result of the target subject based on the second segmentation result.
